(19) United States
(12) Patent Application Publication
(10) Pub. No.: US 2013/0118588 A1
(43) Pub. Date: May 16, 2013

(54) FLUID TREATMENT METHOD

(71) Applicant: Kabushiki Kaisha Kobe Seiko Sho ( Kobe Steel, Ltd.), Kobe-shi (JP)

(72) Inventors: Koji NOISHIKI, Takasago-shi (JP); Makoto Nishimura, Kobe-shi (JP); Takeshi Yamashita, Kobe-shi (JP); Kunihiko Shimizu, Kobe-shi (JP); Yuji Kurishiro, Kobe-shi (JP)

(73) Assignee: Kabushiki Kaisha Kobe Seiko Sho ( Kobe Steel, Ltd.), Kobe-shi (JP)

(21) Appl. No.: 13/668,678

(22) Filed: Nov. 5, 2012

(30) Foreign Application Priority Data
Nov. 11, 2011 (JP) 2011-247670
Dec. 16, 2011 (JP) 2011-276366

(51) Int. Cl. F17D 1/00

(52) U.S. Cl. 137/1

(57) ABSTRACT

Provided is a fluid treatment method for treating fluid by use of a flow passage structure, comprising the steps of: circulating a mixed fluid formed by mutually-mixed plural types of fluid into a mixed fluid flow passage (mixed fluid circulation step); separating, in a separation space leading to the downstream side of the mixed fluid flow passage, the mixed fluid entered from the mixed fluid flow passage into a light fluid with a small specific gravity and a heavy fluid with a larger specific gravity than that of the light fluid in accordance with the difference in specific gravity, in which the separation space has a cross-sectional shape such that the light fluid and the heavy fluid are mutually separated in accordance with the difference in specific gravity; causing the heavy fluid to flow from the separation space to a heavy flow passage leading to an area where the heavy fluid is collected in the separation space; and causing the light fluid to flow from the separation space to a light flow passage leading to an area where the light fluid is collected in the separation space.

### BACKGROUND OF THE INVENTION

1. Field of the Invention

The present invention relates to a fluid treatment method such as a separation method, an extraction method, or a reaction method, by use of a flow passage structure.

2. Description of the Related Art

Conventionally, a flow passage structure as a means for producing an interaction between a plurality of fluids by mutually joining the fluids is known. A microreactor including such a flow passage structure is shown in Japanese Patent Application Laid-Open No. 2009-233483.

The microreactor shown in Japanese Patent Application Laid-Open No. 2009-233483 is provided with a plate on which a flow passage is formed to mutually join two fluids to be passed therethrough. This flow passage formed on the plate includes a first flow passage through which a first fluid that is one of the two fluids is passed, a second flow passage through which a second fluid that is the other fluid is passed, and a mixed fluid flow passage through which a mixed fluid is passed resulting from the joining of the fluids passing through both the flow passages. An inlet for introducing a fluid to each flow passage is formed at each upstream end of the first flow passage and the second flow passage, and the first flow passage and the second flow passage are extended from the respective inlets to the downstream side so as to gradually approach each other. A downstream end of the first flow passage and a downstream end of the second flow passage lead to the upstream end of the mixed fluid flow passage. An outlet for extracting the mixed fluid passing through the mixed fluid flow passage is formed at the downstream end of the mixed fluid flow passage. In the mixed fluid flow passage, an interaction between the first fluid and the second fluid occurs through a contact interface between both the fluids within the mixed fluid, while the mixed fluid is flowing toward the downstream side in a state of slug flow in which a plurality of slugs of the first fluid having a minute length and a plurality of slugs of the second fluid having a minute length are aligned alternately along a circulating direction.

However, in the microreactor of the above-mentioned related art, the mixed fluid is discharged, after the interaction between the first fluid and the second fluid within the mixed fluid, through the outlet of the mixed fluid flow passage in a state where all of the first fluid, the second fluid, a product formed by the interaction and the like contained in the mixed fluid are mixed. Therefore, extremely troublesome separating operation is needed for separating the first fluid and the second fluid from the discharged fluid or for separating the product therefrom.

### SUMMARY OF THE INVENTION

The present invention is thus achieved to solve the above-mentioned problem, and has an object to simplify the separation operation for separating, after an interaction between a plurality of fluids contained in a mixed fluid, a desired fluid or product from the mixed fluid.

In order to accomplish the above-mentioned object, the present invention provides a fluid treatment method for treating fluid by use of a flow passage structure, comprising the steps of: circulating a mixed fluid formed by mutually-mixed plural types of fluid to a mixed fluid flow passage (mixed fluid circulation step); separating, in a separation space leading to the downstream side of the mixed fluid flow passage, the mixed fluid entered from the mixed fluid flow passage into a light fluid with a small specific gravity and a heavy fluid with a larger specific gravity than that of the light fluid in accordance with the difference in specific gravity, the separation space having a cross-sectional shape such that the light fluid and the heavy fluid are mutually separated in accordance with the difference in specific gravity; causing the heavy fluid to flow from the separation space to a heavy flow passage leading to an area where the heavy fluid is collected in the separation space; and causing the light fluid to flow from the separation space to a light flow passage leading to an area where the light fluid is collected in the separation space.

In this flow passage structure, the separation space leading to the downstream side of the mixed fluid flow passage has a cross-sectional shape such that the mixed fluid is separated into the light fluid with a small specific gravity and the heavy fluid with a larger specific gravity than that of the light fluid in accordance with the difference in specific gravity, the heavy flow passage leads to an area where the heavy fluid is collected in the separation space, and the light flow passage leads to an area where the light fluid is collected in the separation space. By using such a flow passage structure, for example, the heavy fluid containing a substance to be separated from the mixed fluid, if the substance is contained in the heavy fluid, can be separated from the separation space through the heavy flow passage, and the light fluid containing a substance to be separated from the mixed fluid, if the substance is contained in the light fluid, can be separated from the separation space through the light flow passage. Namely, such a flow passage structure is used to separate, within a mixed fluid flowing through the mixed fluid flow passage, a desired fluid from the mixed fluid after the interaction between a plurality of fluids contained in the mixed fluid. In this fluid treatment method, since the mixed fluid is separated into a heavy fluid and a light fluid in the separation space inside the flow passage structure, the separation operation on the heavy fluid or the light fluid is unnecessary when the heavy fluid or the light fluid is a desired fluid, and the separation of a desired product from the heavy fluid or light fluid can be, when the desired product is contained in the heavy fluid or the light fluid, preformed with a simple separation operation, compared with the separation of the product from a mixed fluid flowing through a flow passageway in a state where all of plural types of fluid and the product are mixed. Therefore, in this fluid treatment method, the separation operation for separating a desired fluid or product from a mixed fluid after the interaction between a plurality of fluid contained in the mixed fluid can be simplified.

In the above-mentioned fluid treatment method, a cross-section of the separation space in the direction orthogonal to the flow direction of the mixed fluid flowing into the separation space preferably has a corresponding diameter set so that the Froude number on the mixed fluid flowing into the separation space is smaller than 1.

By using such a separation space, the effect of gravity acting on the mixed fluid flowing into the separation space can be enhanced beyond the inertial force in the flow direction of the mixed fluid. Concretely, the Froude number Fr for the mixed fluid flowing into the separation space is represented by mathematical formula: Fr=U/(D·g)^{1/2}. In the formula, U is a flow velocity of the mixed fluid flowing into the separation space, D is the corresponding diameter of a cross-section of the separation space in the direction orthogonal to the flow direction of the mixed fluid, and g is gravity acceleration. The corresponding diameter D of the cross-section of the separation space means, when an equivalent circular cross-section is assumed as a cross-section of a separation space formed in an optional shape, the diameter of the circular cross-section, and is represented by mathematical formula: D=4A/u, wherein D is the corresponding diameter, A is the cross-sectional area of the separation space, and u is the circumferential length of the cross section of the separation space (the length of wet edge in the separation space). The Froude number Fr being smaller than 1 means that the effect of gravity is more dominant than the inertial force in the flow direction of the fluid flowing into the separation space. Therefore, as long as the cross-section of the separation space has a corresponding diameter set so that the Froude number for the mixed fluid flowing into the separation space is smaller than 1 as in the present method, the effect of gravity acting on the mixed fluid flowing into the separation space can be made more dominant than the inertial force in the flow direction of the fluid, and as a result, the mixed fluid can be separated into a heavy fluid and a light fluid by settling down the heavy fluid in the mixed fluid within the separation space. Thus, according to this method, a specific configuration of the separation space having a cross-sectional shape such that the mixed fluid entered from the mixed fluid passage is separated into a light fluid and a heavy fluid in accordance with the difference in specific gravity can be obtained.

The above-mentioned fluid treatment method can be used as a separation method for separating a mixed fluid formed by mutually-mixed plural types of fluid into a light fluid with a small specific gravity and a heavy fluid with a larger specific gravity than that of the light fluid.

In this separation method, the mixed fluid that has passed through the mixed fluid flow passage in the mixed fluid circulation step is carried to the separation space and separated into the light fluid and the heavy fluid within the separation space in the separation step, and the separated light fluid and the separated heavy fluid are carried to the light flow passage and the heavy flow passage, respectively. Therefore, the mixed fluid can be separated, after the interaction between both the fluids within the mixed fluid, into the heavy fluid and the light fluid within the flow passage structure. Consequently, the operation load related to the separation operation on the fluid after discharged from the flow passage structure can be reduced.

The above-mentioned fluid treatment method can further include the steps of: joining a first fluid introduced through a first inlet path and a second fluid introduced through a second inlet path together in a junction part leading to a downstream end of the first inlet path and a downstream end of the second inlet path so as to be mixed with each other; and causing a mixed fluid formed by the first fluid and second fluid joined and mixed with each other in the junction part to flow to the mixed fluid flow passage leading to the downstream side of the junction part.

According to this method, the first fluid and the second fluid are joined so as to be mixed with each other in the junction part only by introducing the first fluid to the first inlet path and introducing the second fluid to the second inlet path, the interaction between both the mixed fluids occurs in the mixed fluid flow passage, and the mixed fluid is thereafter automatically separated into a light fluid and a heavy fluid in accordance with the difference in specific gravity in the separation space. Namely, in this method, all the steps from the mixing of the first fluid and the second fluid to the separation thereof in accordance with the difference in specific gravity can be performed inside the flow passage structure. Therefore, a device needed for mixing both the fluids can be omitted compared with a case where used is a flow passage structure, for example, of which flow passageway is not provided with the first inlet path, the second inlet path, or the junction part so that the first fluid and the second fluid must be mixed outside the flow passage structure prior to the introduction of the mixed fluid to the mixed fluid flow passage. Thus, according to this method, all the steps from the mixing of the first fluid and the second fluid to the separation thereof in accordance with the difference in specific gravity can be performed by use of a flow passage structure with a simple structure.

The above-mentioned fluid treatment method can be used as an extraction method for extracting an object to be extracted from an extraction object fluid containing the object to be extracted into an extracting agent that is a fluid for extracting the object to be extracted from the extraction object fluid by mutually mixing the extraction object fluid and the extracting agent. In this extraction method, one fluid that is one of the extraction object fluid and the extracting agent is introduced to the first inlet path, the other fluid that is the other fluid of the extraction object fluid and the extracting agent is introduced to the second inlet path, and the object to be extracted is extracted, in the mixed fluid circulation step, from the extraction object fluid to the extracting agent through a contact interface between the extraction object fluid and the extracting agent within the mixed fluid.

In this extraction method, since in the extraction step, the object to be extracted is extracted from the extraction object fluid to the extracting agent in a state where the object to be extracted is passing through the mixed fluid flow passage in a state of slug flow in which a plurality of slugs of the extraction object fluid and a plurality of slugs of the extracting agent are alternately aligned, the area of the contact interface between the extraction object fluid and the extracting agent is increased and the extraction of the object to be extracted from the extraction object fluid to the extracting agent can be promoted. Further, in this extraction method, since the mixed fluid after the extraction step is separated into a light fluid and a heavy fluid in the separation space, so that the heavy fluid and the light fluid are carried to the heavy flow passage and the light flow passage respectively; the extracting agent containing the object to be extracted can be carried separately from the separation space to the heavy flow passage if the extracting agent which has extracted the object to be extracted is the heavy fluid, and can be carried separately from the separation space to the light flow passage if the extracting agent which has extracted the object to be extracted is the light fluid. Further, in this extraction method, since the extracting agent containing the object to be extracted can be separated in the separation space inside the flow passage structure, the operation load related to the separation operation of the object to be extracted on the fluid after discharged from the flow passage structure can be reduced.

The above-mentioned fluid treatment method can be used as a reaction method for reacting a first reacting agent and a second reacting agent to each other, which are formed by mutually reactive fluids, by mixing both the reacting agents with each other. In this reaction method, the first reacting agent is introduced to the first inlet path, the second reacting agent is introduced to the second inlet path, and the first reacting agent and the second reacting agent are mutually reacted, in the mixed fluid circulation step, through a contact interface between the first reacting agent and the second reacting agent within the mixed fluid of the first reacting agent and the second reacting agent, while the mixed fluid passes through the mixed fluid flow passage.

In this reaction method, in the reaction step, since the first reacting agent and the second reacting agent are reacted with each other through the contact interface between both the reacting agents while flowing through the mixed fluid flow passage in a state of slug flow in which the respective slugs are alternately aligned, the area of the contact interface between the first reacting agent and the second reacting agent is increased and the reaction between both the reacting agents in the mixed fluid flow passage can be promoted. Further, in this reaction method, since the mixed fluid after the reaction step is separated into a light fluid and a heavy fluid in the separation space, and the heavy fluid and the light fluid are carried to the heavy flow passage and the light flow passage respectively; the heavy fluid containing a reaction product can be, if the reaction product is contained in the heavy fluid, separated from the separation space to the heavy flow passage, and the light fluid containing a reaction product can be, if the reaction product is contained in the light fluid, separated from the separation space to the light flow passage. Further, in this reaction method, since the fluid containing the reaction product can be separated in the separation space inside the flow passage structure, the operation load related to the separation operation of the reaction product on the fluid after discharged from the flow passage structure can be reduced.

In the above-mentioned fluid treatment method, the heavy flow passage may include a heavy fluid outlet opening positioned at a downstream end of the heavy flow passage and formed so as to open into an outer surface of the flow passage structure, so that the heavy fluid can be discharged out of the flow passage structure through the heavy fluid outlet opening. In the above-mentioned treatment method, the light flow passage may include a light fluid outlet opening positioned at a downstream end of the light flow passage and formed so as to open into an outer surface of the flow passage structure, so that the light fluid can be discharged out of the flow passage structure through the light fluid outlet opening.

According to these methods, for example, a substance to be removed from the mixed fluid can be, if it is contained in the heavy fluid, separated from the mixed fluid together with the heavy fluid and discharged out of the flow passage structure. Further, a substance to be acquired from the mixed fluid can be, if it is contained in the heavy fluid, separated from the mixed fluid together with the heavy fluid and extracted out of the flow passage structure. The same can be applied to the case of the light fluid.

In the above-mentioned fluid treatment method, the flow passage structure may include a light flow passage-side inlet path leading to the light flow passage, so that a fluid to be mixed to the light fluid can be joined to the light fluid flowing through the light flow passage through the light flow passage-side inlet path. In the above-mentioned fluid treatment method, the flow passage structure may include a heavy flow passage-side inlet path leading to the heavy flow passage, so that a fluid to be mixed to the heavy fluid can be joined to the heavy fluid flowing through the heavy flow passage through the heavy flow passage-side inlet path.

According to these methods, an additional fluid can be mixed to the heavy fluid to cause an interaction, since the additional fluid can be joined to the heavy fluid flowing through the heavy flow passage through the heavy flow passage-side inlet path. Further, in this method, since the additional fluid can be mixed to the heavy fluid which has been separated from the light fluid in the separation space, in a case where a substance which deteriorates the efficiency of the interaction between the heavy fluid and the additional fluid is present in the mixed fluid and most of the substance is contained in the light fluid separated in the separation space, for example, the additional fluid can be joined to the heavy fluid with a reduced content of the substance to cause the interaction. Therefore, the efficiency of the interaction between the heavy fluid and the additional fluid can be improved. The same effect can be obtained to the case of the light fluid.

In the above-mentioned fluid treatment method, a flow passage structure as described below can be used. Namely, the flow passage structure includes a substrate, a first sealing plate laminated on one side in the thickness direction of the substrate, and a second sealing plate laminated on the other side in the thickness direction of the substrate; the substrate has a first surface facing one side in the thickness direction and a second surface facing the side opposite to the first surface; a first surface-side groove part is formed on the substrate so as to extend along the first surface of the substrate and to open into the first surface, and the mixed fluid flow passage and the light flow passage are formed by sealing an opening of the first surface-side groove part formed on the first surface by means of the first sealing plate; a second surface-side groove is formed on the substrate so as to extend along the second surface of the substrate and to open into the second surface, and the heavy passage is formed by sealing an opening of the second surface-side groove part formed on the second surface by means of the second sealing plate; and a hole part is formed on the substrate to extend through the substrate from the first surface side to the second surface side at a portion located, in the first surface-side groove part, between a portion constituting a downstream end of the mixed fluid flow passage and a portion constituting an upstream end of the light flow passage and to lead to a portion constituting the upstream end of the heavy flow passage in the second surface-side groove part, and the separation space is formed by sealing the opening on the first surface side of the hole part by means of the first sealing plate and sealing the opening on the second surface side of the hole part by means of the second sealing plate.

According to this constitution, a specific arrangement capable of easily constituting the above-mentioned flow passage structure can be obtained. Specifically, in this constitution, the flow passage structure is made into a laminated structure of the substrate, the first sealing plate, and the second sealing plate, and whereby the mixed fluid flow passage and the light flow passage can be formed between the substrate having a groove part on the first surface and the first sealing plate, the heavy flow passage can be formed between the substrate having a groove part on the second surface and the second sealing plate, and further the separation space extending through the substrate from the first surface side to the second surface can be formed.

In the above-mentioned fluid treatment method, a flow passage structure as described below can also be used. Namely, the flow passage structure includes a substrate, a first sealing plate laminated on one side in the thickness direction of the substrate, and a second sealing plate laminated on the other side in the thickness direction of the substrate; the substrate has a first surface facing one side in the thickness direction and a second surface facing the side opposite side to the first surface; a first surface-side groove part is formed on the substrate so as to extend along the first surface of the substrate and to open into the first surface, and the light flow passage is formed by sealing an opening of the first surface-side groove part formed on the first surface by means of the first sealing plate; a second surface-side groove part is formed on the substrate so as to extend along the second surface of the substrate and to open into the second surface, and the mixed fluid flow passage and the heavy flow passage are formed by sealing an opening of the second surface-side groove part by means of the second sealing plate; and a hole part is formed on the substrate so as to extend through the substrate from the second surface side to the first surface side at a portion located, in the second surface-side groove part, between a portion constituting a downstream end of the mixed fluid flow passage and a portion constituting an upstream end of the heavy flow passage and to lead to a portion constituting an upstream end of the light flow passage in the first surface-side groove part, and the separation space is formed by sealing the opening on the first surface side of the hole part by means of the first sealing plate and sealing the opening on the second surface side of the hole part by means of the second sealing plate.

Also according to this constitution, a specific configuration capable of easily constituting the above-mentioned flow passage structure can be obtained. Specifically, in this constitution, the flow passage structure is made into a laminated structure of the substrate, the first sealing plate, and the second sealing plate, and whereby the light flow passage can be formed between the substrate having a groove part on the first surface and the first sealing plate, the mixed fluid flow passage and the heavy flow passage can be formed between the substrate having a groove part on the second surface and the second sealing plate, and further the separation space extending through the substrate from the first surface side to the second surface side can be formed.

In the fluid treatment method of the present invention, the mixed fluid flow passage may be formed within the flow passage structure, a separation header attached to the flow passage structure may further be used, and the separation space may be formed within the separation header.

As described above, according to the present invention, the separation operation for separating, after the interaction between fluids contained in a mixed fluid, a desired fluid or product from the resulting mixed fluid can be simplified.

### BRIEF DESCRIPTION OF THE DRAWINGS

FIG. 1 is a perspective view of a flow passage structure according to a first embodiment of the invention;

FIG. 2 is a top view of a substrate constituting the flow passage structure according to the first embodiment of the invention;

FIG. 3 is a bottom view of the substrate shown in FIG. 2;

FIG. 4 is a partial cross-sectional view of the flow passage structure according to the first embodiment of the invention, which is taken along the line IV-IV in FIG. 2;

FIG. 5 is a partial cross-sectional view of the flow passage structure, which is taken along the line V-V in FIG. 4;

FIG. 6 is a partial cross-sectional view of the flow passage structure, which is taken along the line VI-VI in FIG. 4;

FIG. 7 is a partial cross-sectional view of the flow passage structure, which is taken along the line VII-VII in FIG. 4;

FIG. 8 is a view for illustrating how a mixed fluid which has entered a separation space from a first mixed fluid flow passage flows separately as a heavy flow and a light flow in the flow passage structure according to the first embodiment of the invention;

FIG. 9 is a perspective view of a flow passage structure according to a second embodiment of the invention;

FIG. 10 is a view for illustrating how a mixed fluid which has entered the separation space from the first mixed fluid flow passage flows separately as a heavy fluid and a light fluid in the flow passage structure according to the second embodiment of the invention;

FIG. 11 is a perspective view of a flow passage structure according to a modification example of the invention;

FIG. 12 is a cross-sectional view along a flow passageway of the flow passage structure according to the modification example of the invention, which corresponds to FIG. 4; and

FIG. 13 is a cross-sectional view along a flow passageway of a flow passage structure according to another modification example of the invention, which corresponds to FIG. 4.

FIG. 14 is a perspective view of a fluid circulation device according to a third embodiment of the present invention;

FIG. 15 is a view showing a front surface of a substrate constituting a flow passage structure of the fluid circulation device according to the third embodiment of the present invention;

FIG. 16 is a view showing a rear surface of the substrate shown in FIG. 15;

FIG. 17 is a partial cross-sectional view of the flow passage structure according to the third embodiment of the present invention, taken along the Iv-IV line in FIG. 15;

FIG. 18 is a view for illustrating, in the fluid circulation device according to the third embodiment of the present invention, how a mixed fluid which has entered an internal space of a separation header through a first mixed fluid flow passage flows separately as a heavy fluid and a light fluid;

FIG. 19 is a perspective view of a fluid circulation device according to a fourth embodiment of the present invention;

FIG. 20 is a cross-sectional view of a flow passage structure according to the fourth embodiment of the present invention, which corresponds to FIG. 17; and

FIG. 21 is a view for illustrating, in the fluid circulation device according to the fourth embodiment of the present invention, how a mixed fluid which has entered an internal space of a separation header through a first mixed fluid flow passage flows separately as a heavy fluid and a light fluid.

### DESCRIPTION OF THE PREFERRED EMBODIMENTS

Preferred embodiments of the present invention will be described with reference to the drawings.

### First Embodiment

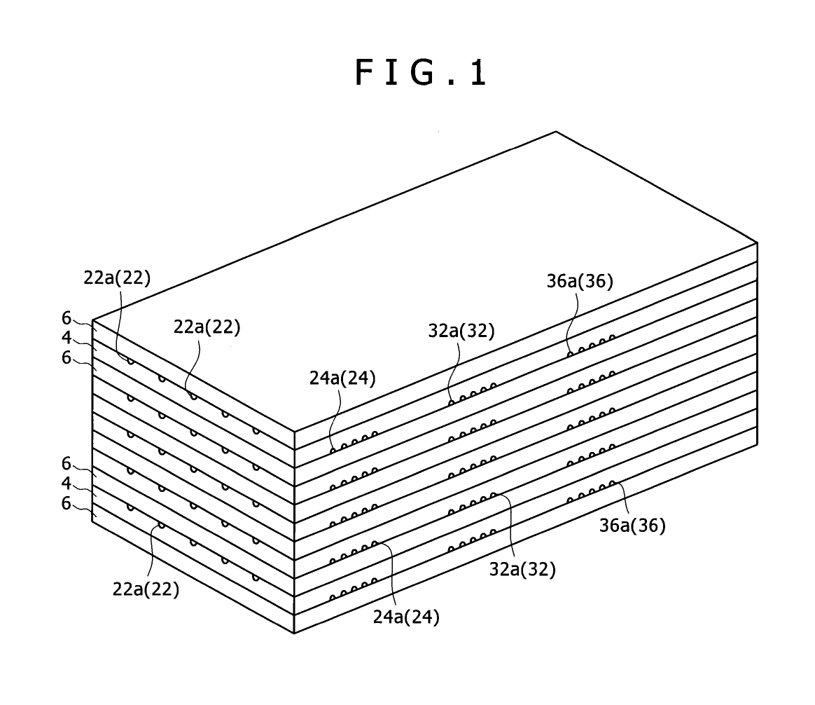

First, a configuration of a flow passage structure according to a first embodiment of the present invention will be described with reference to FIGS. 1 to 8.

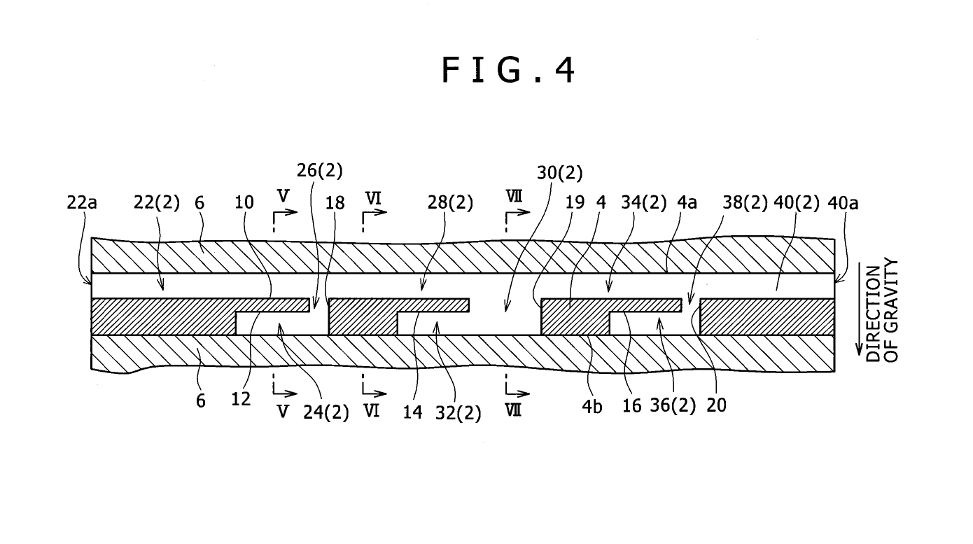

The flow passage structure of the first embodiment, which is used for causing an interaction between a plurality of fluids by mutually mixing both the fluids, includes a flow passageway 2 (refer to FIG. 4) therein for circulating the plurality of fluids so as to be mixed with each other.

Concretely, this flow passage structure is used, for example, in a microreactor, a heat exchanger, an extractor, or the like. When this flow passage structure is used in the microreactor, fluids of plural types of reacting agents which are mutually reactive are circulated through the flow passageway 2 and mixed with each other within the flow passage structure, whereby a chemical reaction is caused as the interaction between both the fluids, and a desired reaction product is obtained. When this flow passage structure is used in the heat exchanger, heat transfer is performed from a predetermined fluid of the plural types of fluid to be circulated through the flow passageway 2 within the flow passage structure to the other fluid. Vaporization or condensation of the fluid may be performed by means of this heat transfer. When this flow passage structure is used in the extractor, one fluid containing an object to be extracted and the other fluid that is an extraction medium are circulated through the flow passageway 2 and mixed with each other within the flow passage structure, and whereby the object to be extracted is extracted from the one fluid to the other fluid.

The flow passage structure includes, as shown in FIG. 1, a plurality of substrates 4 and a plurality of sealing plates 6. Each of these substrates 4 and sealing plates 6 is formed by a rectangular flat plate.

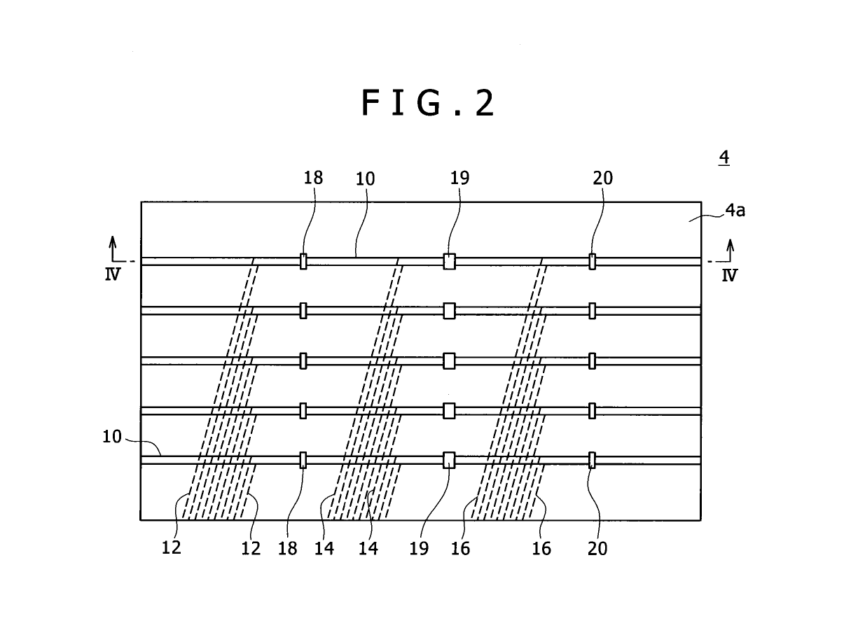

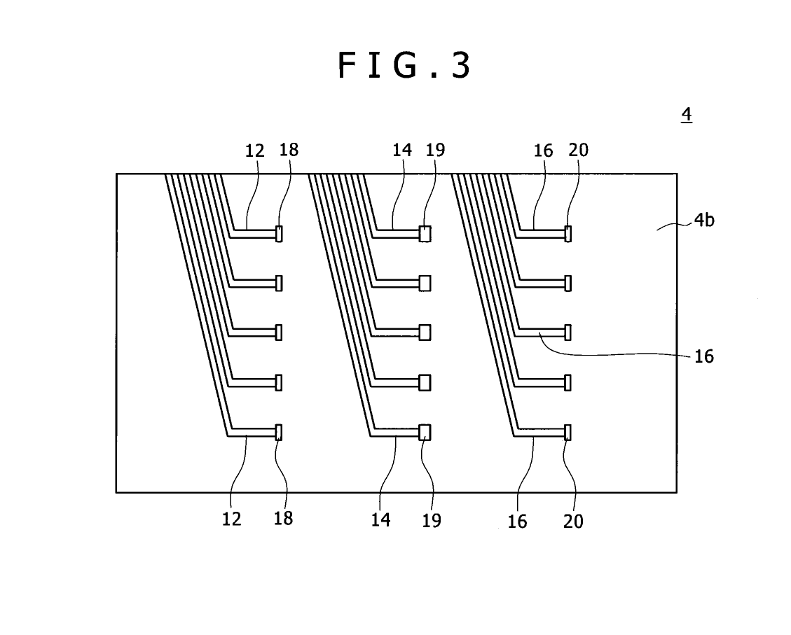

The substrate 4 has a front surface 4a facing one side in the thickness direction (refer to FIG. 2) and a rear surface 4b facing the side opposite to the front surface 4a (refer to FIG. 3). The front surface 4a falls in the scope of the first surface of the present invention and the rear surface 4b falls in the scope of the second surface of the present invention.

A plurality of first groove parts 10 are formed on the substrate 4 by etching so as to extend along the front surface 4a of the substrate 4 and to open into the front surface 4a. The plurality of first groove parts 10 linearly extend from one longitudinal end of the substrate 4 to the other end thereof along the longitudinal direction of the substrate 4. The plurality of first groove parts 10 are arranged so as to be aligned in parallel to each other at equal intervals in a width direction orthogonal to the longitudinal direction of the substrate 4. The first groove part 10 falls in the scope of the first surface-side groove part of the present invention.

Further, a plurality of second groove parts 12, a plurality of third groove parts 14, and a plurality of fourth groove parts 16 are formed on the substrate 4 by etching so as to extend along the rear surface 4b of the substrate 4 and to open into the rear surface 4b. The same number of the second groove parts 12, the third groove parts 14, and the fourth groove parts 16 are provided as the number of the first groove parts 10 formed on the front surface 4a of the substrate 4, respectively. Each second groove part 12, each third groove part 14, and each fourth groove part 16, which are formed on the rear surface 4b of the substrate 4, correspond to each first groove part 10 formed on the front surface 4a of the substrate 4. Each second groove part 12 extends from one width-directional end of the substrate 4 to the other end, bent at a position on the rear surface of the corresponding first groove part 10, and extends toward the other end side in the longitudinal direction of the substrate 4 along the first groove part 10. The plurality of third groove parts 14 are arranged on the other end side of the plurality of second groove parts 12 in the longitudinal direction of the substrate 4 with a space from the plurality of second groove parts 12. The plurality of third groove parts 14 have the same shapes as that of the plurality of second groove parts 12. The third groove part 14 falls in the scope of the second surface-side groove part of the present invention. The plurality of fourth groove parts 16 are arranged on the other end side in the longitudinal direction of the substrate 4 with a space from the plurality of third groove parts 14. The plurality of fourth groove parts 16 have the same shapes as that of the plurality of second groove parts 12.

Further, a plurality of first hole parts 18, a plurality of second hole parts 19, and a plurality of third hole parts 20 are formed on the substrate 4.

Each first hole part 18 is provided at a portion of the substrate 4 where an end of each second groove part 12 overlapped with each first groove part 10 is located, as viewed from a direction vertical to the front surface 4a of the substrate 4. Each first hole part 18 extends through the substrate 4 from the front surface 4a to the rear surface 4b in the thickness direction of the substrate 4 to allow each second groove part 12 to communicate with the first groove part 10 located on the front side thereof.

Each second hole part 19 is provided at a portion of the substrate 4 where an end of each third groove part 14 overlapped with each first groove part 10 is located, as viewed in the direction vertical to the front surface 4a of the substrate 4. Each second hole part 19 extends through the substrate 4 from the front surface 4a to the rear surface 4b in the thickness direction of the substrate 4 to allow each third groove part 14 to communicate with the first groove part 10 located on the front side thereof. Concretely, the second hole part 19 extends through the substrate 4 from the front surface 4a to the rear surface 4b in the thickness direction of the substrate 4, at a portion located between a portion constituting a downstream end of a first mixed fluid flow passage 28 to be described later and a portion constituting an upstream end of a light flow passage 34 to be described later in the first groove part 10; and leads to an end of the third groove part 14 constituting an upstream end of a heavy flow passage 32 to be described later. This second hole part 19 falls in the scope of the hole part of the present invention.

Each third hole part 20 is provided at a portion of the substrate 4 where an end of each fourth groove part 16 overlapped with each first groove part 10 is located as viewed from the direction vertical to the front surface 4a of the substrate 4. Each third hole part 20 extends through the substrate 4 from the front surface 4a to the rear surface 4b in the thickness direction of the substrate 4 to allow each fourth groove part 16 to communicate with the first groove part 10 located on the front side thereof.

The sealing plate 6 is laminated on one side and the other side in the thickness direction of the substrate 4, respectively. Concretely, the substrate 4 and the sealing plate 6 are alternately laminated in the vertical direction. The sealing plate 6 laminated on the front side of the substrate 4 (on one side in the thickness direction of the substrate 4) is diffusively joined to the front surface 4a in a state where the sealing plate 6 covers the front surface 4a of the substrate 4, and the sealing plate 6 laminated on the rear surface of the substrate 4 (on the other side in the thickness direction of the substrate 4) is diffusively joined to the rear surface 4b of the substrate 4 while the sealing plate 6 covers the rear surface 4b. The sealing plate 6 laminated on the front side of the substrate 4 falls in the scope of the first sealing plate in the present invention, and the sealing plate 6 laminated on the rear surface of the substrate 4 falls in the scope of the second sealing plate in the present invention. The sealing plate 6 laminated on the front side of the substrate 4 seals the respective openings of the first groove part 10, the first hole part 18, the second hole part 19, and the third hole part 20, which are formed on the front surface 4a of the substrate 4. The sealing plate 6 laminated on the rear surface of the substrate 4 seals the respective openings of the second groove part 12, the third groove part 14, the fourth groove part 16, the first hole part 18, the second hole part 19, and the third hole part 20, which are formed on the rear surface 4b of the substrate 4.

The flow passage structure is constituted so that the lamination direction of the substrate 4 and the sealing plate 6 constituting the flow passage structure (the thickness direction of the substrate 4 and sealing plate 6) is consistent with the vertical direction. Concretely, the flow passage structure is disposed so that the rear surface 4b of each substrate 4 faces the lower side in the direction of gravity. The flow passage structure has a plurality of flow passageways 2 inside. In the flow passage structure, a plural set of flow passageways 2 are aligned at equal intervals in the lamination direction of the substrate 4 and sealing plate 6, in which each set is formed by a plurality of flow passageways 2 disposed in parallel in the surface direction of the substrate 4. The plural set of flow passageways 2 are formed by a plurality of first to fourth groove parts 10, 12, 14, 16 and a plurality of first to third hole parts 18, 19, 20 of which openings are sealed by the sealing plates 6.

Each flow passageway 2 includes a first inlet path 22, a second inlet path 24, a first junction part 26, a first mixed fluid flow passage 28, a separation space 30, a heavy flow passage 32, a light flow passage 34, a light flow passage-side inlet path 36, a second junction part 38, and a second mixed fluid flow passage 40 (refer to FIG. 4).

The first inlet path 22 is an area into which a first fluid is introduced and carried. This first inlet path 22 has a first inlet opening 22a for introducing the first fluid to the first inlet path 22. The first inlet opening 22a is opened into a side surface of the flow passage structure, which faces one side in the longitudinal direction of the flow passage structure parallel to the front surface 4a of the substrate 4, and positioned at the upstream end of the first inlet path 22. The first inlet path 22 extends horizontally and linearly from the first inlet opening 22a along the longitudinal direction of the flow passage structure. The first inlet path 22 is formed by a portion positioned on the side opposite to the second hole part 19 across the first hole part 18, in the first groove part 10 in which the opening formed on the surface 4a of the substrate 4 is sealed by the sealing plate 6. The cross-sectional shape of the first inlet path 22 in the direction orthogonal to the circulating direction of the first fluid flowing through the first inlet path 22 (the longitudinal direction of the first inlet path 22) has a semicircular shape of which arc-like portion faces the lower side (the rear surface 4b side of the substrate 4).

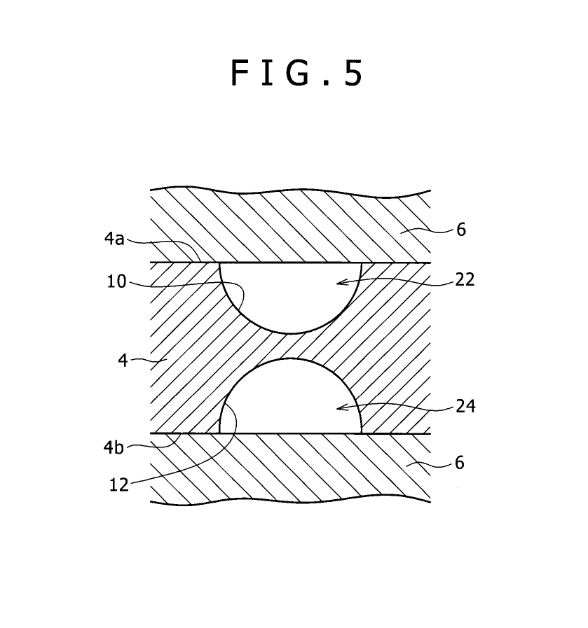

The second inlet path 24 is an area into which a second fluid is introduced and carried. The second inlet path 24 has a second inlet opening 24a for introducing the second fluid to the second inlet path 24. The second inlet opening 24a is opened into a side surface of the flow passage structure, which faces one side in the lamination direction of the substrate 4 and the sealing plate 6 and a width direction orthogonal to the longitudinal direction of the flow passage structure, and positioned at an upstream end of the second inlet path 24. The second inlet path 24 horizontally extends from the side surface having the second inlet opening 24a of the flow passage structure to the surface opposite thereto, is bent at a position below the first inlet path 22 of the flow passageway 2 to which the second inlet path 24 belongs, and extends horizontally and linearly to a downstream side of the first inlet path 22 along the first inlet path 22. The second inlet path 24 is formed by the second groove part 12 in which the opening formed on the rear surface 4b of the substrate 4 is sealed by the sealing plate 6. The cross-sectional shape of the second inlet path 24 in the direction orthogonal to the circulating direction of the second fluid flowing through the second inlet path 24 has, as shown in FIG. 5, a semicircular shape of which arc-like portion faces the upper side (the front surface 4a side of the substrate 4). The cross-sectional shape of the second inlet path 24 is symmetrical to the cross-sectional shape of the first inlet path 22.

The first junction part 26 (refer to FIG. 4) is an area for mutually joining the first fluid flowing through the first inlet path 22 and the second fluid flowing through the second inlet path 24 in the vertical direction (the thickness direction of the substrate 4) so that both the fluids are mixed with each other. This first junction part 26 falls in the scope of the junction part of the present invention. The first junction part 26 leads to the downstream end of the first inlet path 22 and the downstream end of the second inlet path 24. The first junction part 26 is formed by the first hole part 18 of which opening on the front surface 4a side of the substrate 4 is sealed by the sealing plate 6 jointed to the surface 4a and of which opening on the rear surface 4b side of the substrate 4 being sealed by the sealing plate 6 joined to the rear surface 4b. The cross-sectional shape of the first junction part 26 in the direction orthogonal to the circulating direction of the first fluid flowing through the first inlet path 22 has a shape such that two semicircles disposed symmetrically to each other in the vertical direction are joined together at a portion in the vicinity of their apexes. In the first junction part 26, the first fluid linearly enters the first inlet path 22, and the second fluid carried from the second inlet path 24 to the first junction part 26 is joined to the first fluid while moving toward the upper side (the surface 4a side of the substrate 4).

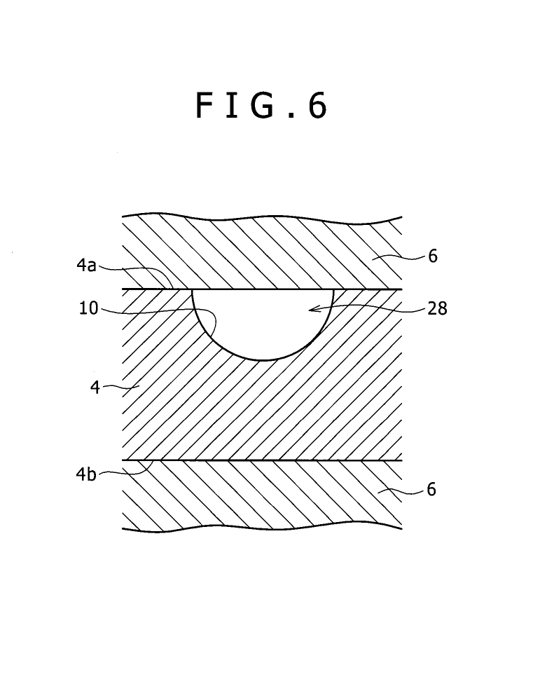

The first mixed fluid flow passage 28 (refer to FIG. 4) is an area through which a mixed fluid formed by the first fluid and the second fluid which are joined and mixed with each other in the first junction part 26 passes. This first mixed fluid flow passage 28 falls in the scope of the mixed fluid flow passage in the present invention. The first mixed fluid flow passage 28 is constituted so that the mixed fluid flows in a state of slug flow in which a plurality of fine slugs of the first fluid and a plurality of fine slugs of the second fluid are alternately aligned along the circulating direction. The upstream end of the first mixed fluid flow passage 28 leads to a downstream side of the first junction part 26; and the first mixed fluid flow passage 28 horizontally and linearly extends, on the same straight line as that of the first inlet path 22 leading to an upstream side of the first junction part 26, in the same direction as that of the first inlet path 22. The mixed fluid horizontally flows to the downstream side in the state of slug flow within the first mixed fluid flow passage 28, and in the mixed fluid, an interaction occurs between the first fluid and the second fluid through contact interfaces between the slugs of the first fluid and the slugs of the second fluid. The first mixed fluid flow passage 28 is disposed at a position at an equal level with the first inlet path 22. The first mixed fluid flow passage 28 is formed by a portion located between the first hole part 18 and the second hole part 19, in the first groove part 10 of which the opening formed on the front surface 4a of the substrate 4 is sealed by the sealing plate 6 laminated on the front side of the substrate 4. The cross-sectional shape of the first mixed fluid flow passage 28 in the direction orthogonal to the circulating direction of the fluid flowing through the first mixed fluid flow passage 28 (the longitudinal direction of the first mixed fluid flow passage 28) is, as shown in FIG. 6, a semicircular shape of which arc-like portion faces the lower side (the rear surface 4b side of the substrate 4). The cross-sectional shape of the first mixed fluid flow passage 28 is the same as the cross-sectional shape of the first inlet path 22.

The separation space 30 is an area for separating the mixed fluid entered from the first mixed fluid flow passage 28 into a light fluid with a small specific gravity and a heavy fluid with a larger specific gravity than that of the light fluid. The separation space 30 leads to the downstream end of the first mixed fluid flow passage 28. The separation space 30 is formed by the second hole part 19 of which opening on the front surface 4a side of the substrate 4 is sealed by the sealing plate 6 laminated on the front side of the substrate 4 and joined to the front surface 4a and of which opening on the rear surface 4b side of the substrate 4 is sealed by the sealing plate 6 laminated on the rear surface of the substrate 4 and joined to the rear surface 4b. The separation space 30 has a cross-sectional shape such that the mixed fluid entered from the first mixed fluid flow passage 28 is naturally separated into a light fluid and a heavy fluid in accordance with the difference in specific gravity. Concretely, a cross section of the separation space 30 in the direction orthogonal to the circulating direction of the mixed fluid carried from the first mixed fluid flow passage 28 to the separation space 30 has a corresponding diameter set so that the Froude number on the mixed fluid flowing into the separation space 30 is smaller than 1. More specifically, when the Froude number on the mixed fluid flowing into the separation space 30 is Fr, the field number Fr is represented by the following equation (1), and a corresponding diameter D of the cross section of the separation space 30 is set so that the Froude number Fr is smaller than 1.

Fr=U/(D·g)^{1/2} (1)

In this equation (1), U is the flow velocity of the mixed fluid flowing into the separation space 30, and g is gravity acceleration. In a case where the flow rate of the fluid to be circulated to the flow passageway 2 is about 10 ml/min or less, the Froude number Fr becomes smaller than 1 if the corresponding diameter of the separation space 30 is about 2 mm or more.

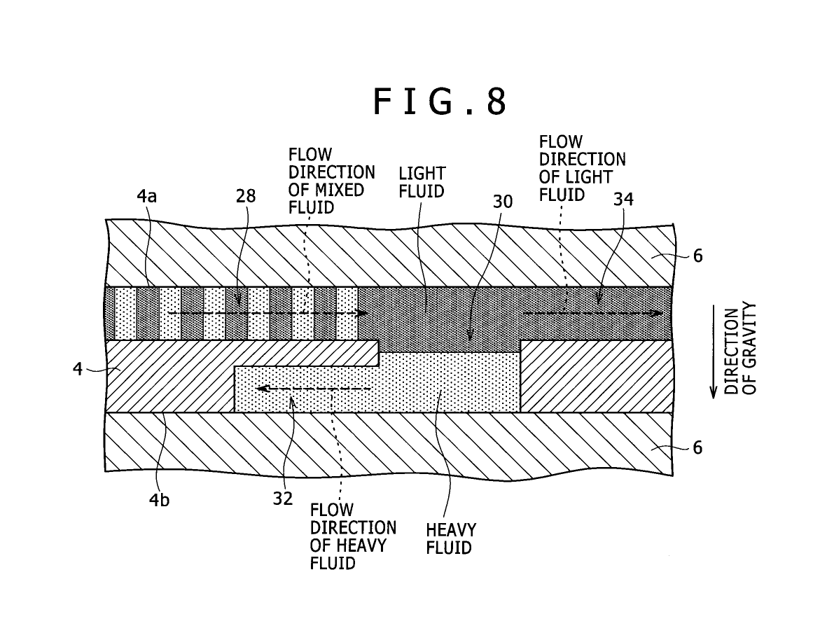

The Froude number Fr being smaller than 1 means that the effect of gravity acting on the mixed fluid is more dominant than the inertial force in the flow direction of the mixed fluid flowing into the separation space 30. Therefore, the heavy fluid in the mixed fluid flowing into the separation space 30 is settled down under the effect of gravity than that of the inertial force, and as a result, the heavy fluid and the light fluid in the mixed fluid are naturally separated from each other. In the separation space 30, the heavy fluid is collected in a lower area of the separation space 30 (an area close to the rear surface 4b of the substrate 4), while the light fluid is suspended on the upper side of the heavy fluid (on the front surface 4a side of the substrate 4) (refer to FIG. 8).

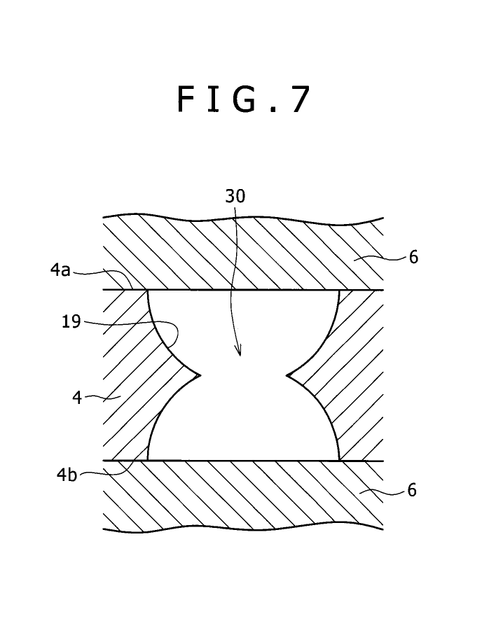

The downstream end of the first mixed fluid flow passage 28 leads to the separation space 30 in an area from the position of the upper end of the separation space 30 (the position of the front surface 4a of the substrate 4) to a position slightly below the position of the center of the separation space 30 in the vertical direction (the thickness direction of the substrate 4). The separation space 30 has a cross-sectional shape such that, as shown in FIG. 7, two semicircles disposed symmetrically to each other in the vertical direction are mutually joined at a portion in the vicinity of their apexes. The length of the separation space 30 in the inflow direction of the mixed fluid to the separation space 30 is larger than the length of the first junction part 26 in the inflow direction of the first fluid to the first junction part 26.

The heavy flow passage 32 is a flow path through which the heavy fluid enters from the separation space 30 and the heavy fluid is discharged out of the flow passage structure. The upstream end of the heavy flow passage 32 leads to an area where the heavy fluid is collected in the separation space 30. Concretely, the upstream end of the heavy flow passage 32 leads to the separation space 30 in an area from the position of the lower end of the separation space 30 (the position of the rear surface 4b of the substrate 4) to a position slightly below the position of the center of the separation space 30 in the vertical direction. The upstream end of the heavy flow passage 32 leads to the separation space 30 at a position below the downstream end of the first mixed fluid flow passage 28. The heavy flow passage 32 horizontally extends from the connecting part with the separation space 30 to the upstream side of the first mixed fluid flow passage 28 along the first mixed fluid flow passage 28, and is then bent so as to horizontally extend toward the side surface on which the second inlet opening 24a of the flow passage structure is formed.

The heavy flow passage 32 has a heavy fluid outlet opening 32a (refer to FIG. 1) through which the heavy fluid is discharged from the heavy flow passage 32. The heavy fluid outlet opening 32a is positioned at the downstream end of the heavy flow passage 32, and formed so as to open into the side surface of the flow passage structure on which the second inlet opening 24a is formed. The flowing direction of the heavy fluid carried from the separation space 30 to the heavy flow passage 32 is turned toward the heavy fluid outlet opening 32a in accordance with the bent shape of the heavy flow passage 32 after the heavy fluid flows horizontally in the direction opposite to the flow of the mixed fluid in the first mixed fluid flow passage 28, and the heavy fluid is discharged out of the flow passage structure through the heavy fluid outlet opening 32a. The heavy flow passage 32 is formed by the third groove part 14 in which the opening formed on the rear surface 4b of the substrate 4 is sealed by the sealing plate 6. The cross-sectional shape of the heavy flow passage 32 in the direction orthogonal to the circulating direction of the heavy fluid flowing in the heavy flow passage 32 is the same as the cross-sectional shape of the second inlet path 24.

The light flow passage 34 is a flow path through which the light fluid enters from the separation space 30. The upstream end of the light flow passage 34 leads to an area where the light fluid collected in the separation space 30. Concretely, the upstream end of the light flow passage 34 leads to the separation space 30 in an area from the position of the upper end of the separation space 30 (the position of the front surface 4a of the substrate 4) to a position slightly above the position of the center of the separation space 30 in the vertical direction (the thickness direction of the substrate 4). The upstream end of the light flow passage 34 leads to the separation space 30 at a position located above the upstream end of the heavy flow passage 32. The upstream end of the light flow passage 34 leads to a portion located on the side opposite to the connecting portion with the first mixed fluid flow passage 28 in the separation space 30. The light flow passage 34 is disposed at a position at an equal level with the first mixed fluid flow passage 28, and linearly extends, on the same straight line as the first mixed fluid flow passage 28, in the same direction as the extending direction of the first mixed fluid flow passage 28. The light fluid entered from the separation space 30 to the light flow passage 34 flows to the downstream side along the light flow passage 34 in the horizontal direction. The light flow passage 34 is formed by a portion located between the second hole part 19 and the third hole part 20 in the first groove part 10 in which the opening formed on the front surface 4a of the substrate 4 is sealed by the sealing plate 6. The cross-sectional shape of the light flow passage 43 in the direction orthogonal to the flow direction of the light fluid flowing through the light flow passage 34 (in the longitudinal direction of the light flow passage 34) is the same as the cross-sectional shape of the first inlet path 22 and the cross-sectional shape of the first mixed fluid flow passage 28.

The light flow passage-side inlet path 36 is an area where an additional fluid to be mixed to the light fluid is introduced. The light flow passage-side inlet path 36 leads to the light flow passage 34 so as to join the additional fluid introduced to the light flow passage-side inlet path 36 to the light fluid flowing through the light flow passage 34. Concretely, the light flow passage-side inlet path 36 is connected to the light flow passage 34 through the second junction part 38. The light flow passage-side inlet path 36 has a light flow passage-side inlet opening 36a for introducing fluid to the light flow passage-side inlet path 36. This light flow passage-side inlet opening 36a is positioned at the upstream end of the light flow passage-side inlet path 36, and formed so as to open into the side surface of the flow passage structure on which the second inlet opening 24a and the heavy fluid outlet opening 32a are formed. The light flow passage-side inlet path 36 is formed by the fourth groove part 16 in which the opening formed on the rear surface 4b of the substrate 4 is sealed by the sealing plate 6. The configuration other than the above light flow passage-side inlet path 36 is the same as the second inlet path 24. The additional fluid may be a fluid of different type from the first fluid and the second fluid, a fluid of the same type as the first fluid, or a fluid of the same type as the second fluid.

The second junction part 38 is an area in which the light fluid flowing through the light flow passage 34 and the additional fluid flowing through the light flow passage-side inlet path 36 are mutually joined in the vertical direction (the thickness direction of the substrate 4). The second junction part 38 leads to the downstream end of the light flow passage 34 and the downstream end of the light flow passage-side inlet path 36. The second junction part 38 is formed by the third hole part 30 of which opening on the front surface 4a side of the substrate 4 is sealed by the sealing plate 6 joined to the front surface 4a and of which the opening on the rear surface 4b side of the substrate 4 is sealed by the sealing plate 6 joined to the rear surface 4b. In the second junction part 38, the light fluid is linearly entered from the light flow passage 34, and the additional fluid carried from the light flow passage-side inlet path 36 to the second junction part 38 is joined to the light fluid while moving toward the upper side (to the front surface 4a side of the substrate 4). The configuration other than the above second junction part 38 is the same as that of the first junction part 26.

The second mixed fluid flow passage 40 is a flow path through which a mixed fluid flows formed by the light fluid and additional fluid which are joined in the second junction part 38. The upstream end of the second mixed fluid flow passage 40 leads to the downstream side of the second junction part 38, and the second mixed fluid flow passage 40 horizontally and linearly extends, on the same straight line as the light flow passage 34 leading to the upstream side of the second junction part 38, in the same direction as the light flow passage 34. The mixed fluid flowing through the second mixed fluid flow passage 40 is horizontally carried to the downstream side in the state of slug flow, in which an interaction between the fluids constituting the mixed fluid occurs within the mixed fluid. The configuration other than the above second mixed fluid flow passage 40 is the same as the above-mentioned configuration of the first mixed fluid flow passage 28.

The thus-constituted flow passage structure according to the first embodiment is used in a microreactor, a heat exchanger, an extractor, or the like, as described above. Among usage examples thereof, usage of the flow passage structure according to the first embodiment as an extractor, and usage of the flow passage structure as a microreactor (reactor) will be then described.

Firstly, the usage of the flow passage structure according to the first embodiment as the extractor, or an extraction method using the flow passage structure according to the first embodiment is described.

In this extraction method, the above-mentioned flow passage structure is used to mix an extraction object fluid containing an object to be extracted with an extracting agent that is a fluid for extracting the object to be extracted from the extraction object fluid, to extract the object to be extracted from the extraction object fluid to the extracting agent.

Concretely, the extraction object fluid is introduced to the first inlet path 22 through the first inlet opening 22a of each flow passageway 2 at a predetermined flow rate, while the extracting agent is introduced to the second inlet path 24 through the second inlet opening 24a of each flow passageway 2 at a predetermined flow rate.

The extraction object fluid introduced to the first inlet path 22 flows through the first inlet path 22 and enters the first junction part 26, while the extracting agent introduced to the second inlet path 24 flows through the second inlet path 24 and enters the first junction part 26. The extraction object fluid and the extracting agent are mutually joined so as to be mixed with each other in the first junction part 26. A mixed fluid formed by the extraction object fluid and extracting agent which has been joined in the first junction part 26 enters the first mixed fluid flow passage 28 and flows to the downstream side within the first mixed fluid flow passage 28 in a state of slug flow in which a plurality of fine slugs of the extraction object fluid and a plurality of fine slugs of the extracting agent are alternately aligned along the circulating direction of the mixed fluid. Within this mixed fluid, the object to be extracted is extracted from the extraction object fluid to the extracting agent through contact interfaces between the slugs of the extraction object fluid and the slugs of the extracting agent.

Thereafter, the mixed fluid is carried from the first mixed fluid flow passage 28 to the separation space 30 and separated into a light fluid and a heavy fluid in accordance with the difference in specific gravity within the separation space 30. When the extracting agent has a larger specific gravity than that of the extraction object fluid, for example, the extracting agent is settled down as the heavy fluid, and the extraction object fluid is suspended above the extracting agent as the light fluid. The extracting agent as the heavy fluid that has been settled down contains a lot of the object to be extracted, and the content percentage of the object to be extracted in the extraction object fluid as the light fluid suspended above the extracting agent is lower than that of the object to be extracted in the extraction object fluid introduced to the first inlet path 22.

The heavy fluid separated in the separation space 30 is passed to the heavy flow passage 32 and discharged out of the flow passage structure through the heavy fluid outlet opening 32a. Meanwhile, the light fluid separated in the separation space 30 is passed to the light flow passage 34 and carried from the light flow passage 34 to the second junction part 38.

A new extracting agent is introduced to the light flow passage-side inlet path 36 through the light flow passage-side inlet opening 36a at a predetermined flow rate, and this extracting agent is carried to the second junction part 38 through the light flow passage-side inlet path 36 and joined to the light fluid.

The mixed fluid formed by the light fluid and extracting agent which has been joined in the second junction part 38 enters the second mixed fluid flow passage 40 and flows to the downstream side within the second mixed fluid flow passage 40 in a state of slug flow in which a plurality of fine slugs of the extraction object fluid and a plurality of fine slugs of the extracting agent are aligned alternately in the circulating direction. Within this mixed fluid, the object to be extracted is further extracted from the extraction object fluid to the extracting agent. Finally, the mixed fluid is discharged and collected through a final outlet opening 40a of each flow passageway 2.

The extraction method using the flow passage structure of a first embodiment is performed as described above.

Next, the usage of the flow passage structure according to the first embodiment as the microreactor, or a reaction method using the flow passage structure according to the first embodiment is described.

In this reaction method, the above-mentioned flow passage structure is used to cause the first reacting agent and the second reacting agent, which are mutually reactive, to react with each other by mixing a fluid of the first reacting agent and a fluid of the second reacting agent.

Concretely, the first reacting agent is introduced to the first inlet path 22 through the first inlet opening 22a of each flow passageway 2 at a predetermined flow velocity, while the second reacting agent is introduced to the second inlet path 24 through the second inlet opening 24a of each flow passageway 2 at a predetermined flow velocity.

The first reacting agent introduced to the first inlet path 22 flows through the first inlet path 22 and enters the first junction part 26, while the second reacting agent introduced to the second inlet path 24 flows through the second inlet path 24 and enters the first junction part 26. The first reacting agent and the second reacting agent are mutually joined so as to be mixed with each other in the first junction part 26. A mixed fluid formed by the first reacting agent and second reacting agent which has been joined in the first junction part 26 enters the first mixed fluid flow passage 28 and flows to the downstream side within the first mixed fluid flow passage 28 in a state of slug flow in which a plurality of fine slugs of the first reacting agent and a plurality of fine slugs of the second reacting agent are alternately aligned along the circulating direction of the mixed fluid. Within this mixed fluid, the reaction between the first reacting agent and the second reacting agent occurs through contact interfaces of the slugs of the first reacting agent and the slugs of the second reacting agent, and whereby a reaction product is formed.

Thereafter, the mixed fluid is carried from the first mixed fluid flow passage 28 to the separation space 30, and separated into a light fluid and a heavy fluid in the separation space 30 in accordance with the difference in specific gravity. When the fluid of the reaction product has a larger specific gravity than that of the other components in the mixed fluid, for example, the fluid of the reaction product is settled down as the heavy fluid, and the fluid of the other components is suspended above the fluid of the reaction product as the light fluid. This light fluid is formed by an unreacted first reacting agent and second reacting agent.

The reaction product as the heavy fluid, which has been separated in the separation space 30, is carried to the heavy flow passage 32 and taken out of the flow passage structure through the heavy fluid outlet opening 32a. Meanwhile, the light fluid, which has been separated in the separation space 30, flows to the light flow passage 34 and enters the second junction part 38 from the light flow passage 34.

Then, an additional second reacting agent is introduced to the light flow passage-side inlet path 36 through the light flow passage-side inlet opening 36a at a predetermined flow rate, and this second reagent is carried to the second junction part 38 through the light flow passage-side inlet path 36 and joined to the light fluid. This mixed fluid formed by the light fluid and the additional second reacting agent enters the second mixed fluid flow passage 40 and flows to the downstream side within the second mixed fluid flow passage 40, in a state of slug flow in which a plurality of fine slugs of the unreacted first reacting agent and a plurality of fine slugs of the unreacted second reacting agent to which an additional second reacting agent is added are alternately aligned along the circulating direction. Within this mixed fluid, a reaction product is formed through further reaction between the first reacting agent and the second reacting agent. Finally, the mixed fluid including the reaction product is discharged out and collected through the final outlet opening 40a of each flow passageway 2.

The reaction method using the flow passage structure of the first embodiment is performed as described above.

In this first embodiment, an area of a contact interface between the first fluid and the second fluid per unit volume in the mixed fluid can be increased to promote the interaction between the first fluid and the second fluid, since the mixed fluid flows in a state of slug flow in which a plurality of slugs of the first fluid and a plurality of slugs of the second fluid are alternately aligned in the first mixed fluid flow passage 28 of the passageway 2. Concretely, in the extraction method using the flow passage structure of the first embodiment, an area of a contact interface between the extraction object fluid as the first fluid and the extracting agent as the second fluid can be increased to promote extraction of the object to be extracted from the extraction object fluid to the extracting agent. Further, in the reaction method using the flow passage structure of the first embodiment, an area of a contact interface between the first reacting agent as the first fluid and the second reacting agent as the second fluid can be increased to promote the reaction between both the reacting agents.

In the first embodiment, the effect of gravity acting on the mixed fluid flowing into the separation space 30 becomes stronger than the effect of inertial force in the flow direction, since the separation space 30 leading to the downstream side of the first mixed fluid flow passage 28 has a corresponding diameter set so that the Froude number Fr for the mixed fluid flowing into the separation space 30 is smaller than 1; and the mixed fluid is thus naturally separated into a light fluid and a heavy fluid in accordance with the difference in specific gravity. Further, since the heavy flow passage 32 leads to a portion in the separation space 30 where the heavy fluid in the mixed fluid is collected, and the heavy fluid outlet opening 32a positioned at the downstream end of the heavy flow passage 32 is formed so as to open into the side surface of the flow passage structure; the heavy fluid separated in the separation space 30 can be discharged out of the flow passage structure through the heavy fluid outlet opening 32a. Accordingly, when a substance to be separated and removed by separation from the mixed fluid is contained in the heavy fluid, or when a substance to be obtained from the mixed fluid is contained in the heavy fluid, the heavy fluid containing such a substance can be taken out of the flow passage structure. Concretely, in the extraction method, when the extracting agent which has extracted the object to be extracted from the extraction object fluid is the heavy fluid, the extracting agent containing the object to be extracted can be taken out of the flow passage structure through the heavy fluid outlet opening 32a. In the reaction method, when the fluid containing the reaction product formed by the reaction between the first reacting agent and the second reacting agent is the heavy fluid, the fluid containing a reaction product therefrom can be taken out of the flow passage structure through the heavy fluid outlet opening 32a.

In this first embodiment, the operation load required for separation operation which is performed after discharge of the fluid to the outside of the flow passage structure can be reduced, since the mixed fluid is separated into a heavy fluid and a light fluid in the separation space 30 of the flow passageway 2 inside the flow passage structure. Concretely, if a plural types of fluid and product material flowing through the flow passageway are discharged out of the flow passage structure in an entirely mixed state, a quite troublesome separation operation is needed to acquire a desired fluid or substance from this discharged fluid. In the first embodiment, however, since the heavy fluid is separated from the mixed fluid inside the flow passage structure, the separation operation is unnecessary when the heavy fluid is a desired fluid, and a desired substance, when contained in the heavy fluid, can be separated from the heavy fluid through a simple separation operation, compared to a case where a desired substance is separated from the mixed fluid flowing through the flow passageway in a state where a plural types of fluid and substances are entirely mixed with each other.

In this first embodiment, further, an additional fluid can be interacted with the light fluid flowing through the light flow passage 34, since the additional fluid can be joined to the light fluid through the light flow passage-side inlet path 36 and the second junction part 38. Furthermore, since the additional fluid is joined to the light fluid which has been separated from the heavy fluid in the separation space 30 in the first embodiment, in a case where a substance which deteriorates the efficiency of the interaction between the light fluid and the additional fluid is present in the mixed fluid and the most part of the substance is contained in the heavy fluid, the additional fluid can be joined to and interacted with the light fluid of which content of the substance is reduced. Therefore, the efficiency of the interaction between the light fluid and the additional fluid can be improved. Concretely, in the extraction method, since the extraction efficiency is deteriorated when a large amount of the extracting agent after extracting the object to be extracted is present in the mixed fluid, the extraction efficiency can be improved by joining a new extracting agent, as an additional fluid, to the light fluid after separating the extracting agent which has been extracted as a heavy fluid. In the reaction method, since the reaction efficiency is deteriorated when a large amount of a reaction product formed by the reaction between the first reacting agent and the second reacting agent is present in the mixed fluid, the reaction efficiency can be improved by joining a new second reacting agent, as an additional fluid to the light fluid after the heavy fluid containing the reaction product is separated therefrom.

### Second Embodiment

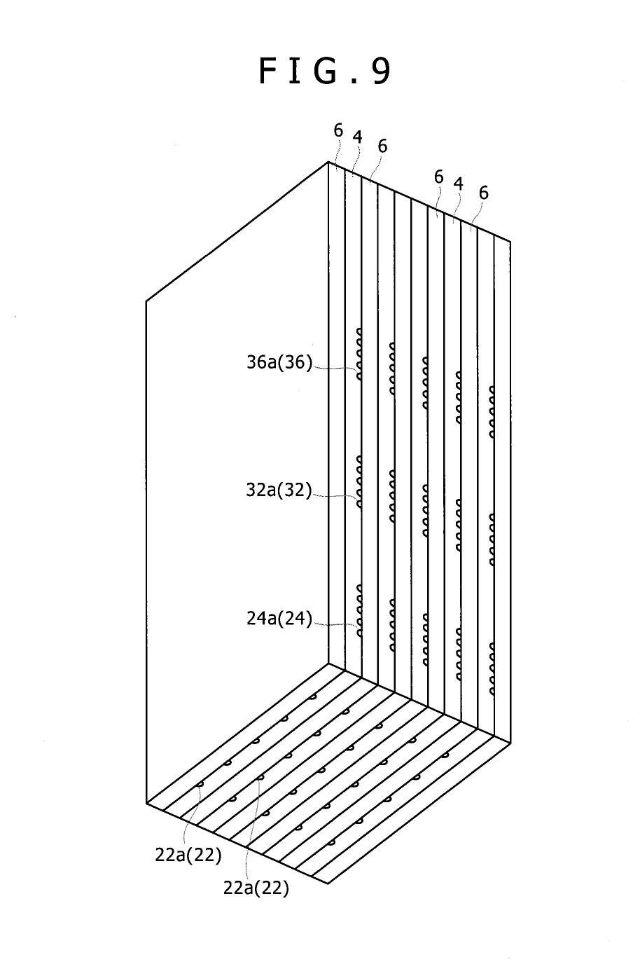

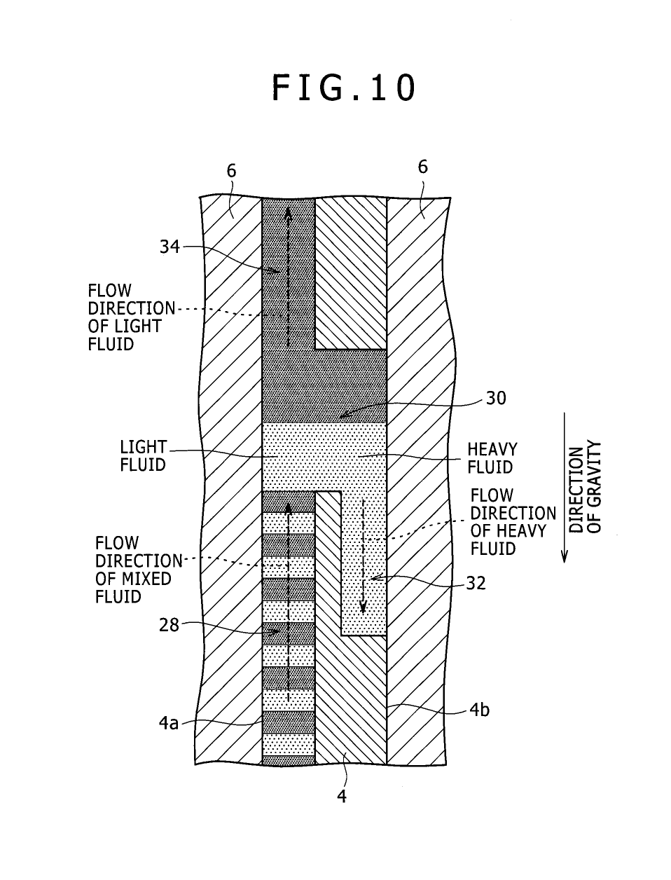

A configuration of a flow passage structure according to a second embodiment of the present invention will be described with reference to FIGS. 9 and 10.

The flow passage structure of the second embodiment is a vertically arranged flow passage structure of the horizontally arranged flow passage structure of the above-mentioned first embodiment (refer to FIG. 9). Concretely, the flow passage structure according to the second embodiment is arranged so that the front surface 4a and rear surface 4b of each substrate 4 are parallel to each other in the vertical direction. More specifically, the flow passage structure according to the second embodiment is arranged so that a side surface on which the first inlet opening 22a is formed is directed downward in the direction of gravity, and a side surface of which the final outlet opening 40a is formed is directed upward. Accordingly, the first inlet path 22, the first mixed fluid flow passage 28, the light flow passage 34, and the second mixed fluid flow passage 40 of each flow passageway 2 within the flow passage structure are arranged so as to extend in the top-to-bottom direction (the vertical direction). A part extending along the first inlet path 22 of the second inlet path 24 in each flow passageway 2, a part extending along the first mixed fluid flow passage 28 of the heavy flow passage 32 in each flow passageway 2, and a part extending along the light flow passage 34 of the light flow passage-side inlet path 36 in each flow passageway 2 are also arranged so as to extend in the top-to-bottom direction (the vertical direction).

The first inlet path 22 and the second inlet path 24 lead to the lower end of the first junction part 26, and the upstream end of the first mixed fluid flow passage 28 leads to the upper end of the first junction part 26. The downstream end of the first mixed fluid flow passage 28 and the upstream end of the heavy flow passage 32 lead to the lower end of the separation space 30. The upstream end of the light flow passage 34 leads to the upper end of the separation space 30, and the downstream end of the light flow passage 34 and the downstream end of the light flow passage-side inlet path 36 lead to the lower end of the second junction part 38. The upstream end of the second mixed fluid flow passage 40 leads to the upper end of the second junction part 38.

In this flow passage structure of the second embodiment, the first fluid is introduced to the first inlet path 22 from underneath through the first inlet opening 22a, and the second fluid is introduced to the second inlet path 24 from the side through the second inlet opening 24a. The first fluid introduced to the first inlet path 22 flows from downward to upward within the first inlet path 22 and enters the first junction part 26; and the second fluid introduced to the second inlet path 24 changes the flow direction along the bent shape of the second inlet path 24 and enters the first junction part 26. In the first junction part 26, the second fluid gets closer substantially horizontally to and joined to the first fluid flowing linearly upward. The mixed fluid formed by the first fluid and second fluid joined in the first junction part 26 flows the first mixed fluid flow passage 28 upward in a state of slug flow, and the interaction between the first fluid and the second fluid occurs within the mixed fluid. The mixed fluid flowing through the first mixed fluid flow passage 28 enters the separation space 30 from underneath.

In the separation space 30, as shown in FIG. 10, the mixed fluid is separated vertically into a light fluid and a heavy fluid. Concretely, the heavy fluid in the mixed fluid is collected in a lower area within the separation space 30, or an area close to the heavy flow passage 32 and the first mixed fluid flow passage 28 in the separation space 30, and the light fluid in the mixed fluid is collected in an upper area within the separation space 30, or an area close to the light flow passage 34 in the separation space 30. In this state, the light fluid in the mixed fluid flowing into the separation space 30 from the first mixed fluid flow passage 38 passes through a layer of the heavy fluid collected in the separation space 30 and is suspended above the layer of the heavy fluid. The heavy fluid separated in the separation space 30 enters the heavy flow passage 32 in a downward direction, changes its direction along the bent shape of the heavy flow passage 32, and discharged to the side of the flow passage structure through the heavy fluid outlet opening 32a. Meanwhile, the light fluid separated in the separation space 30 flows through the light flow passage 34 from downward to upward and enters the second junction part 38.

An additional fluid is then introduced through the light flow passage-side inlet opening 36a from the side of the flow passage structure, this additional fluid flows through the light flow passage-side inlet path 36, similarly to the second fluid flowing through the second inlet path 24, and is joined to the light fluid in the second junction part 38. The mixed fluid formed by the light fluid and the additional fluid joined in the second junction part 38 enters the second mixed fluid flow passage 40, and flows from downward to upward through the second mixed fluid flow passage 40 in the state of slug flow. Within this mixed fluid, an interaction occurs. The resulting mixed fluid is discharged to the upper side of the flow passage structure through the final outlet opening 40a.

In this flow passage structure of the second embodiment, the light fluid in the mixed fluid carried from the first mixed fluid flow passage 28 to the separation space 30 passes through a layer of the heavy fluid collected within the separation space 30 and suspended upward, since the first mixed fluid flow passage 28 is connected to the lower end of the separation space 30. At that time, since a contact interface between the light fluid and the heavy fluid is renewed, the interaction between the light fluid and the heavy fluid can be promoted within the separation space 30.

The effects other than the above because of the flow passage structure of the second embodiment are similar to those of the first embodiment.

The embodiments disclosed herein should be considered to be illustrative and not restrictive in every point. The scope of the present invention is not defined by the above description of the embodiments but is defined by the claims, and all the changes that fall within the meanings and scope that are equivalent to the claims are intended to be included in the claims.

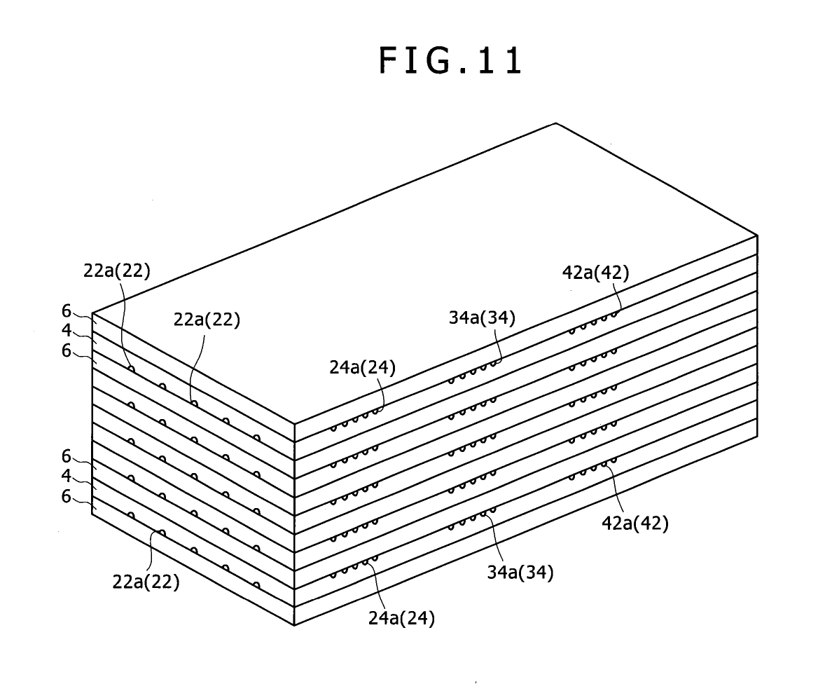

For example, the light flow passage 34 may include a light fluid outlet opening 34a for discharging the light fluid from the light flow passage 34, as in a modification example shown in FIG. 11. Concretely, the light flow passage 34 may extend, for example, to a side surface of the flow passage structure in a bent shape like the heavy flow passage 32 of the above-mentioned embodiment, on which the light fluid outlet opening 34a is formed at the downstream end of the light flow passage 34.

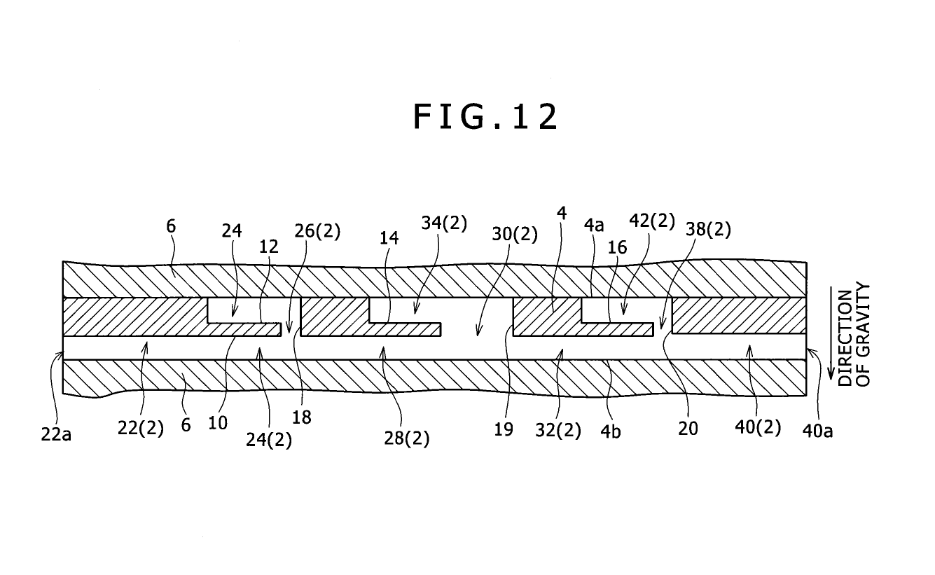

The flow passage structure of this modification example can be formed, for example, by forming the second to fourth groove parts 12, 14, 16 so as to extend along the front surface 4a of the substrate 4 and to open into the front surface 4a, instead of forming so as to extend along the rear surface 4b of the substrate 4 in the above-mentioned first embodiment; forming the first groove part 10 so as to extend along the rear surface 4b of the substrate 4 and to open into the rear surface 4b, instead of forming so as to extend along the front surface 4a of the substrate 4 therein; and laminating the sealing plate 6 on the front side and rear surface of the substrate 4, respectively. In this case, the third groove part 14 of the second to fourth groove parts 12, 14, 16 formed to extend along the front surface 4a of the substrate 4 falls in the scope of the first surface-side groove part of the present invention, and the first groove part 10 formed to extend along the rear surface 4b of the substrate 4 falls in the scope of the second surface-side groove part in the present invention. In this case, as shown in FIG. 12, the first inlet path 22, the fixed mixed fluid flow passage 28, the heavy flow passage 32 and the second mixed fluid flow passage 40 are arranged on the rear surface 4b side (the lower side) of the substrate 4, and the second inlet path 24, the light flow passage 34, and the heavy flow passage-side inlet path 42 are arranged on the front surface 4a side (the upper side) of the substrate 4.

In this modification example, the first inlet path 22 is formed by a portion located on the side opposite to the second hole part 19 across the first hole part 18 in the first groove part 10 in a state where the opening formed on the rear surface 4b of the substrate 4 is sealed by the sealing plate 6 laminated on the rear surface of the substrate 4. The second inlet path 24 is formed by the second groove part 12 in a state where the opening formed on the front surfaced 4a of the substrate 4 is sealed by the sealing plate 6 laminated on the front side of the substrate 4. The first mixed fluid flow passage 28 is formed by a portion located between the first hole part 18 and the second hole part 19 in the first groove part 10 in a state where the opening formed on the rear surface 4b of the substrate 4 is sealed by the sealing plate 6 laminated on the rear surface 4b of the substrate 4.

The light flow passage 34 is formed by the third groove part 14 in a state where the opening formed on the front surface 4a of the substrate 4 is sealed by the sealing plate 6 laminated on the front side of the substrate 4, and the heavy flow passage 32 is formed by a portion located between the second hole part 19 and the third hole part 20 in the first groove part 10 in a state where the opening formed on the rear surface 4b of the substrate 4 is sealed by the sealing plate 6 laminated on the rear surface of the substrate 4. Namely, the light flow passage 34 leads to an upper portion of the separation space 30, and extends to the side surface on which the second inlet opening 24a of the flow passage structure is formed in a bent shape corresponding to the heavy flow passage 32 of the above-mentioned first embodiment; and the heavy flow passage 32 linearly extends, on the same straight line as the first mixed fluid flow passage 28, in the same direction. The downstream end of the heavy flow passage 32 leads to the second junction part 38.

The second hole part 19 extends through the substrate 4 from the rear surface 4b side to the front surface 4a side in the thickness direction of the substrate 4, at a portion located between a portion constituting the downstream end of the first mixed fluid flow passage 28 and a portion constituting the upstream end of the heavy flow passage 34 in the first groove part 10 extending along the rear surface 4b of the substrate 4; and leads to a portion constituting the upstream end of the light flow passage 34 in the third groove part 14 extending along the front surface 4a of the substrate 4. The separation space 30 is formed by sealing the opening on the front surface 4a side of the second hole part 19 by the sealing plate 6 laminated on the front side of the substrate 4, and sealing the opening on the rear surface 4b side of the second hole part 19 by the sealing plate 6 laminated on the rear surface of the substrate 4.

The second mixed fluid flow passage 40 is formed by a portion located on the side opposite to the second hole part 19 across the third hole part 20 in the first groove part 10 in a state where the opening formed on the rear surface 4b of the substrate 4 is sealed by the sealing plate 6 laminated on the rear surface of the substrate 4. The upstream end of the second mixed fluid flow passage 40 leads to a lower portion of the second junction part 38.

The heavy flow passage-side inlet path 42, which is an area where an additional fluid to be mixed to the heavy fluid is introduced, is connected to the heavy flow passage 32 through the second junction part 38 so that the fluid flowing through the heavy flow passage-side inlet path 42 is joined to the heavy fluid flowing through the heavy flow passage 32. The heavy flow passage-side inlet path 42 is formed by the fourth groove part 16 in a state where the opening formed on the front surface 4a of the substrate 4 is sealed by the sealing plate 6. Namely, the heavy flow passage-side inlet path 42 is formed in a bent shape corresponding to the light flow passage-side inlet path 36 in the first embodiment, and leads to an upper portion of the second junction part 38. The heavy flow passage-side inlet path 42 has a heavy flow passage-side inlet opening 42a for introducing fluid to the heavy flow passage-side inlet path 42. The heavy flow passage-side inlet opening 42a is positioned at the upstream end of the heavy flow passage-side inlet path 42, and formed so as to open into the side surface on which the second inlet opening 24a and the light fluid outlet opening 34a are formed in the flow passage structure.

According to the configuration of this modification example, the light fluid separated in the separation space 30 can be discharged out of the flow passage structure from the light fluid outlet opening 34a through the light flow passage 34. Therefore, when a substance to be removed from the mixed fluid is contained in the light fluid, the light fluid containing the substance to be removed can be separated from the mixed fluid and discharged out of the flow passage structure. When a substance to be obtained from the mixed fluid is contained in the light fluid, the light fluid containing the substance can be separated from the mixed fluid and taken out of the flow passage structure.

According to the configuration of this modification example, an additional fluid can be interacted with the heavy fluid flowing through the heavy flow passage 32, since the additional fluid can be joined to the heavy fluid through the heavy flow passage-side inlet path 42. In this configuration, furthermore, since an additional fluid can be joined to the heavy fluid which has been separated from the light fluid in the separation space 30; in a case where, for example, a substance which deteriorates the efficiency of the interaction between the heavy fluid and the fluid introduced from the heavy flow passage-side inlet path 42 is present in the mixed fluid, and the most part of the substance is contained in the light fluid separated in the separation space 30, it is possible to join the fluid to the heavy fluid, of which content of the substance is reduced, from the heavy flow passage-side inlet path 42 and to cause an interaction therewith. Therefore, the efficiency of the interaction between the heavy fluid and the fluid introduced from the heavy flow passage-side inlet path 42 can be improved.

By arranging the flow passage structure of the above-described first embodiment upside down so that the top surface becomes the bottom surface, the heavy flow passage 32 in the first embodiment may be used as the light flow passage for discharging the light fluid separated in the separation space 30 to the outside, the light flow passage 34 in the above-described first embodiment may be used as the heavy flow passage leading to the second junction part 38, and the light flow passage-side inlet path 36 in the first embodiment may be used as the fourth flow passage leading to the heavy flow passage.

Each component constituting the flow passageway may be formed in various structures other than the above-mentioned structure.

For example, the first inlet path may be extended or bent obliquely relative to the extending direction of the first mixed fluid flow passage. The second inlet path may be linearly extended without bending. In this case, the second inlet path may be extended in the direction parallel, oblique, or orthogonal to the extending direction of the first inlet path. The first mixed fluid flow passage may be bent in the flow direction of the mixed fluid. The heavy flow passage may be linearly extended from the separation space, or may be extended in the direction oblique to the first mixed fluid flow passage. The heavy flow passage may be extended from the separation space in the direction orthogonal to the first mixed fluid flow passage. The light flow passage may be extended from the separation space in a direction different from the extending direction of the first mixed fluid flow passage, for example, in the direction orthogonal to the first mixed fluid flow passage or a direction oblique to the first mixed fluid flow passage. The light flow passage may be formed in a shape bent in the flow direction of the light fluid. The light flow passage-side inlet path may be linearly extended without bending. In this case, the light flow passage-side inlet path may be extended in the direction oblique or orthogonal to the extending direction of the light flow passage. The second mixed fluid flow passage may be bent or folded back a predetermined number of times in the flow direction of the mixed fluid. Each component constituting the flow passageway may have a cross-sectional shape other than the above.

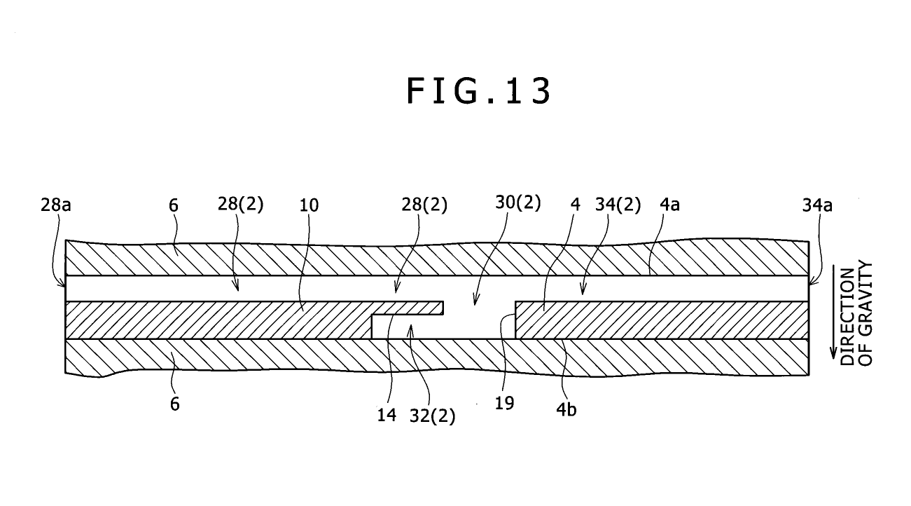

Further, the flow passageway 2 may be formed only by the first mixed fluid flow passage 28, the separation space 30, the heavy flow passage 32, and the light flow passage 34 as in another modification example shown in FIG. 13. Concretely, in this modification example, the first mixed fluid flow passage 28 extends to a side surface facing one side in the longitudinal direction of the flow passage structure parallel to the front surface 4a of the substrate 4 in the flow passage structure, and has an inlet opening 28a opened into this side surface. Namely, in this modification example, the flow passage structure is not provided with the first inlet path, the second inlet path and the first junction part, and a mixed fluid prepared by mixing plural types of fluid outside the flow passage structure is introduced to the first mixed fluid flow passage 28 through the inlet opening 28a. In this modification example, the light flow passage 34 extends to a side surface opposite to the side surface on which the inlet opening 28a is opened in the flow passage structure, and has a light fluid outlet opening 34a opened into this side surface. Namely, in this modification example, the flow passage structure is not provided with the light flow passage-side inlet path, the second junction part, and the second mixed fluid flow passage, and the light fluid flowing into the light flow passage 34 after being separated in the separation space 30 is carried to the downstream side and discharged out from the light fluid outlet opening 34a. The configuration other than the above of the flow passage structure in this modification example is similar to the flow passage structure of the above-described first embodiment.

The flow passage structure of this modification example can be used as a separation device for separating an externally prepared mixed fluid into a light fluid and a heavy fluid. A mixed fluid separation method using such a flow passage structure as a separation device will be then described.

In this separation method, a mixed fluid is prepared by mixing plural types of fluid outside the flow passage structure. The prepared mixed fluid is introduced to the first mixed fluid flow passage 28 through the inlet opening 28a of the first mixed fluid flow passage 28 at a predetermined flow velocity, and the mixed fluid is passed to the downstream side of the first mixed fluid flow passage 28.

This mixed fluid is carried from the first mixed fluid passage 28 to the separation space 30, and separated into a light fluid and a heavy fluid in the separation space 30 in accordance with the difference in specific gravity. The heavy fluid separated in the separation space 30 is carried to the heavy flow passage 32 and discharged through the heavy fluid outlet opening (not shown in FIG. 13), while the light fluid separated in the separation space 30 is carried to the light flow passage 34 and discharged through the light fluid outlet opening 34a.

The mixed fluid separation method using the flow passage structure of this modification example is performed as described above.

In this separation method, the operation load related to the separation operation on the fluid after being discharged from the flow passage structure can be reduced, since the mixed fluid can be separated in the separation space 30 inside the flow passage structure after the interaction between both the fluids within the mixed fluid.

The flow passage structure shown in FIG. 13 may be used upside down. In this case, the light flow passage 34 in FIG. 13 is used as the heavy flow passage, and the heavy flow passage 32 in FIG. 13 is used as the light flow passage.

In each of the above-mentioned embodiments, the light flow passage-side inlet path and the second junction part in the flow passageway may be omitted. Namely, in each of the above-mentioned embodiments, an outlet opening opened into the outer surface of the flow passage structure may be provided at the downstream end of the light flow passage. In the modification example shown in FIGS. 11 and 12, the heavy flow passage-side inlet path and the second junction part in the flow passageway may be omitted. Namely, in this modification example, the outlet opening opened into the outer surface of the flow passage structure may be provided at the downstream end of the heavy flow passage.

The flow passageway may include a plurality of separation spaces.

The flow passage structure may be formed only by one structure, in which a sealing plate is joined to each of the front and rear surfaces of a single substrate on which grooves for forming flow passageways are formed.

Further, in the flow passage structure, a temperature conditioning flow passage for carrying a fluid for temperature control may be arranged between flow passageways adjacent to each other in the lamination direction of the substrate and the sealing plate.

The above-mentioned first fluid, second fluid, additional fluid to be mixed to the light fluid, and additional fluid to be mixed to the heavy fluid may be liquid or gas.

The first mixed fluid flow passage and the second mixed fluid flow passage do not necessarily have to be constituted so that the mixed fluid flowing through the passages is carried in a state of slug flow. Namely, the first mixed fluid flow passage and the second mixed fluid flow passage may be constituted so that the mixed fluid flowing through the flow passages is carried, for example, in a state of laminar flow.

### Third Embodiment

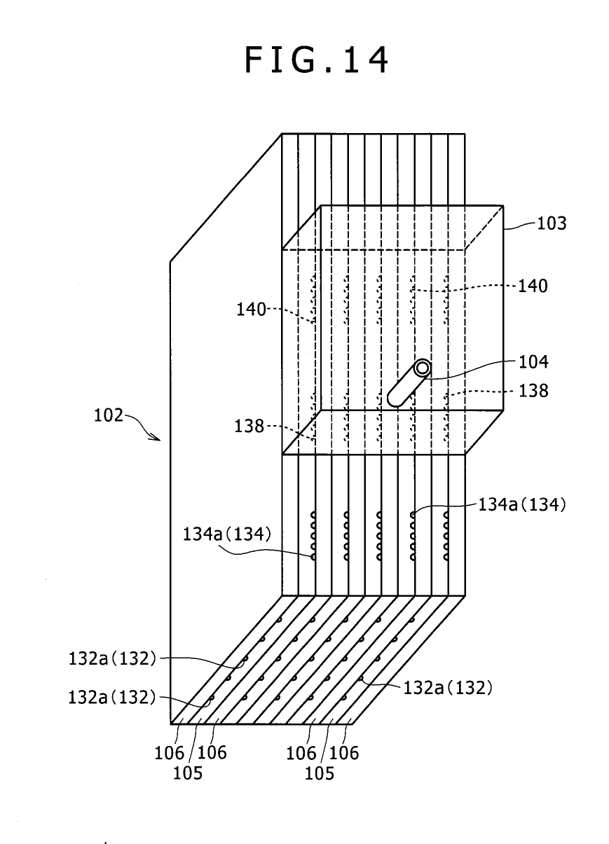

A configuration of a fluid circulation device according to a third embodiment of the present invention will be described with reference to FIGS. 14 to 18.

The fluid circulation device according to the third embodiment is configured to cause an interaction between a plurality of fluids by circulating the fluids so as to be mixed with each other.

Concretely, the fluid circulation device is used, for example, in a microreactor, a heat exchanger, an extractor or the like. In the case where this fluid circulation device is used in a microreactor, plural types of fluids of reacting agents which are mutually reactive are circulated through the fluid circulation device and mixed with each other therein, and whereby a desired reaction product can be obtained through a chemical reaction as an interaction between the fluids. When this fluid circulation device is used in a heat exchanger, heat transfer is performed from a predetermined fluid in plural types of fluids circulating through the fluid circulation device to the other fluid. Further, vaporization or concentration of the fluid may be performed by means of this heat transfer. In the case where this fluid circulation device is used in an extractor, one fluid containing an object to be extracted and the other fluid that is an extraction medium are circulated through the fluid circulation device and mixed with each other therein, so that the object to be extracted is extracted from the one fluid to the other fluid.

The fluid circulation device according to the third embodiment includes a flow passage structure 102, a separation header 103, and an outlet nozzle 104.

The flow passage structure 102 is a rectangular parallelepiped structure; in which an inlet-side flow passageway 102a for circulating a first fluid and a second fluid so as to be mixed with each other and introducing a resulting fluid after the mixing to an internal space 103a of the separation header 103 to be described later, and an outlet-side flow passageway 102b for discharging the fluid from the internal space 103a of the separation header 103 and circulating the fluid while an additional fluid is added thereto are formed. The inlet-side flow passageway 102a falls into the scope of the flow passageway according to the present invention. The flow passage structure 102 includes, as shown in FIG. 14, a plurality of substrates 105 and a plurality of sealing plates 106. The substrates 105 and the sealing plates 106 are formed by a rectangular flat plate, respectively.

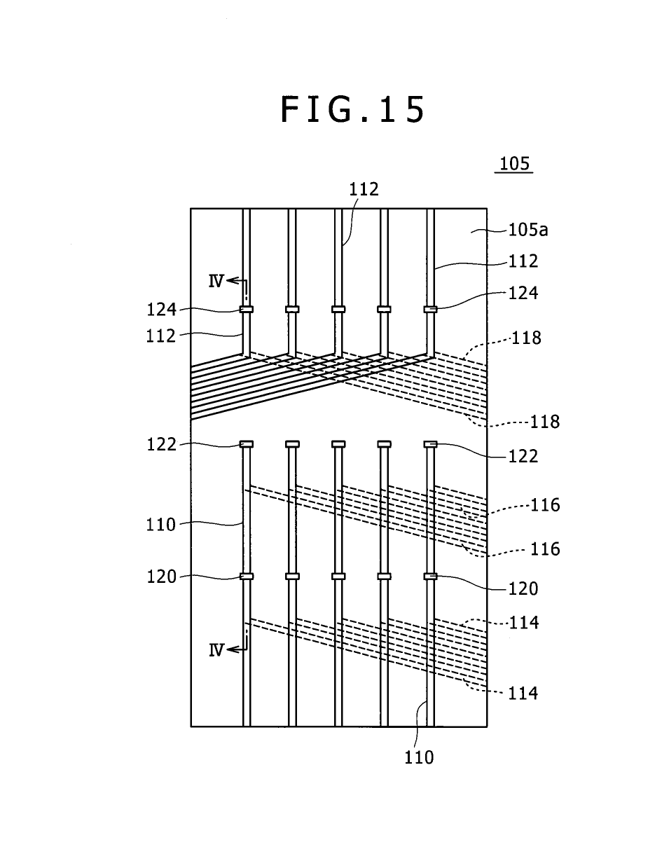

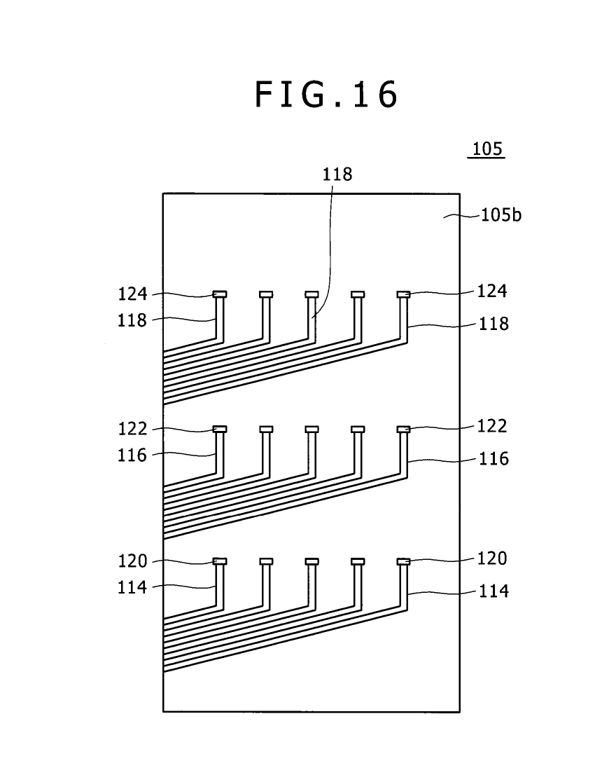

The substrate 105 has a front surface 105a facing one side in the thickness direction (refer to FIG. 15) and a rear surface 105b facing the side opposite to the front surface 105a (refer to FIG. 16). A plurality of first groove parts 110 and a plurality of second groove parts 112 are formed on the front surface 105a of the substrate 105 through etching. The first groove parts 110 and the second groove parts 112 are provided in an equal number to each other. The plurality of first groove parts 110 extend linearly along the longitudinal direction of the substrate 105 from one longitudinal end of the substrate 105 toward the other end, so as to terminate at predetermined intermediate positions of the substrate 105. Further, the plurality of first groove parts 110 are arranged so as to be in parallel to each other at equal intervals in the width direction orthogonal to the longitudinal direction of the substrate 105. The plurality of second groove parts 112 are arranged toward the other end side relative to the plurality of first groove parts 110 in the longitudinal direction of the substrate 105 with a space therebetween. The plurality of second groove parts 112 extend from one width-directional end of the substrate 105 toward the other end, are bent on an extension of each of the corresponding first groove parts 110, and extend to the other longitudinal end of the substrate 105 in the same direction as that of each of the corresponding first groove parts 110.

A plurality of third groove parts 114, a plurality of fourth groove parts 116 and a plurality of fifth groove parts 118 are formed on the rear surface 105b of the substrate 105 through etching. The third groove parts 114, the fourth groove parts 116 and the fifth groove parts 118 are provided in an equal number to each other and the number of which is the same as that of the first groove parts 110 formed on the front surface 105a of the substrate 105. Each third groove part 114, each fourth groove part 116 and each fifth groove part 118, which are formed on the rear surface 105b of the substrate 105 correspond to each first groove part 110 and each second groove part 112, which are formed on the front surface 105a of the substrate 105, respectively. The plurality of third groove parts 114, the plurality of fourth groove parts 116 and the plurality of fifth groove parts 118 are arranged from one longitudinal end of the substrate 105 toward the other end with intervals therebetween. The plurality of third groove parts 114 extend from one width-directional end of the substrate 105 toward the other end, are bent at a position on the rear side of each of the corresponding first groove parts 110, and further extend toward the other longitudinal end of the substrate 105 along the first groove parts 110. The shape of the plurality of fourth groove parts 116 is the same as that of the plurality of third groove parts 114. The shape of the plurality of fifth groove parts 118 is the same as that of the plurality of third groove parts 114. The plurality of fifth groove parts 118 extend from the one width-directional end of the substrate 105 on which the ends of the third groove parts 114 are formed toward the other end, are bent at a position on the rear side where each of the corresponding second groove parts 112 are bent, and further extend toward the other longitudinal end of the substrate 105 along the portions in the second groove parts 112 extending in the longitudinal direction of the substrate 105.

A plurality of first hole parts 120, a plurality of second hole parts 122 and a plurality of third hole parts 124 are formed on the substrate 105.

Each first hole part 120 is provided at a portion of the substrate 105 where an end of each third groove part 114 overlapped with each first groove part 110 is located as viewed from the direction vertical to the front surface 105a of the substrate 105. Each first hole part 120 extends through the substrate 105 from the front surface 105a to the rear surface 105b in the thickness direction to allow each third groove part 114 to communicate with each first groove part 110 located on the front side thereof.

Each second hole part 122 is provided at a portion of the substrate 105 where an end of each fourth groove part 116 overlapped with an end of the second groove part 112 of each first groove part 110 is located as viewed from the direction vertical to the front surface 105a of the substrate 105. Each second hole part 122 extends through the substrate 105 from the front surface 105a to the rear surface 105b in the thickness direction to allow each fourth groove part 116 to communicate with each first groove part 110 located on the front side thereof.

Each third hole part 124 is provided at a portion on the substrate 105 where an end of each fifth groove part 118 overlapped with each second groove part 112 is located as viewed from the direction vertical to the front surface 105a of the substrate 105. Each third hole part 124 extends through the substrate 105 from the front surface 105a to the rear surface 105b in the thickness direction to allow each fifth groove part 118 to communicate with each second groove part 112 located on the front side thereof.

The sealing plate 106 is laminated alternately with the substrate 105. The sealing plate 106 laminated on the front side of the substrate 105 is diffusively bonded to the front surface 105a of the substrate 105 in a state where the front surface 105a is covered therewith, and the sealing plate 106 laminated on the rear side of the substrate 105 is diffusively bonded to the rear surface 105b of the substrate 105 in a state where the rear surface 105b is covered therewith. The sealing plate 106 laminated on the front surface 105a of the substrate 105 seals each opening of the first groove part 110, the second groove part 112, the first hole part 120, the second hole part 112 and the third hole part 124, which are formed on the front surface 105a of the substrate 105. The sealing plate 106 laminated on the rear surface 105b of the substrate 105 seals each opening of the third groove part 114, the fourth groove part 116, the fifth groove part 118, the first hole part 120, the second hole part 122 and the third hole part 124, which are formed on the rear surface 105b of the substrate 105.

The flow passage structure 102 is arranged so that the longitudinal direction of the substrate 105 and the sealing plate 106 constituting the flow passage structure 102, that is, the extending direction of the first groove part 110 coincides with the vertical direction (the direction of gravity). The flow passage structure 102 includes, inside thereof, the plurality of inlet-side flow passageways 102a and the plurality of outlet-side flow passageways 102b. The inlet-side flow passageways 102a and the outlet-side flow passageways 102b are provided so as to correspond to each other in one-on-one. The outlet-side flow passageways 102b and the inlet-side flow passageways 102a are vertically arranged within the flow passage structure 102 with intervals therebetween. Within the flow passage structure 102, the plurality of inlet-side flow passageways 102a are arranged in parallel along the front surface 105a, and also the rear surface 105b of the substrate 105 and the plurality of outlet-side flow passageways 102b are arranged in parallel. The plurality of inlet-side flow passageways 102a arranged in parallel form one set, and plural sets of the inlet-side flow passageways 102a are disposed with equal intervals therebetween in the lamination direction of the substrate 105 and sealing plate 106. The plurality of outlet-side flow passageways 102b arranged in parallel form one set, and plural sets of the outlet-side flow passageways 102b are disposed with equal intervals therebetween in the lamination direction of the substrate 105 and the sealing plate 106.

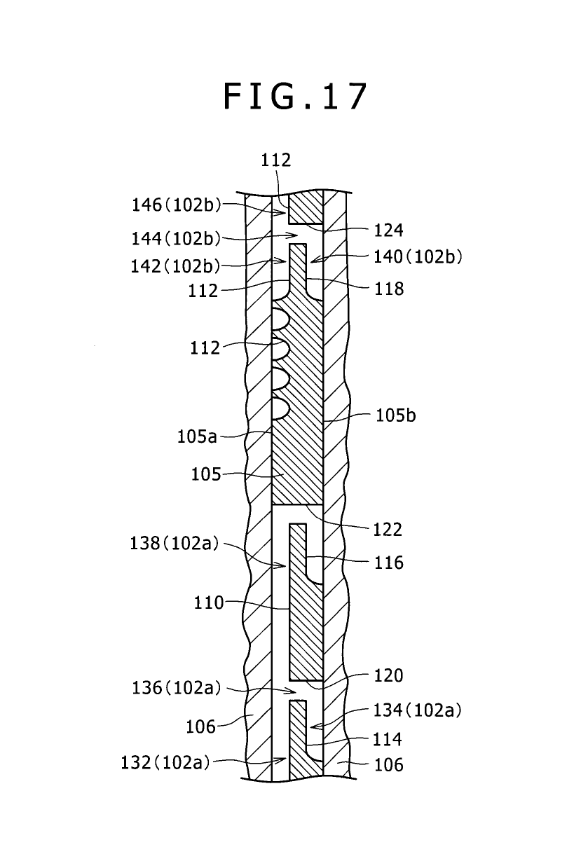

Each inlet-side flow passageway 102a includes, as shown in FIG. 17, a first inlet path 132, a second inlet path 134, a first junction part 136 and a first mixed fluid flow passage 138.

The first inlet path 132 is an area into which the first fluid is introduced to pass therethrough. This first inlet path 132 has a first inlet opening 132a for introducing the first fluid to the first inlet path 132 (refer to FIG. 14). The first inlet opening 132a is opened into the lower surface of the flow passage structure 102, and positioned at an upstream end of the first inlet path 132. The first inlet path 132 linearly extends upward from the first inlet opening 132a along the longitudinal direction of the flow passage structure 102. The first inlet path 132 is formed by a portion positioned on the side opposite to the second hole part 122 relative to the first hole part 120 in the first groove part 110 of which opening formed on the surface 105a of the substrate 105 is sealed by the sealing plate 106.

The second inlet path 134 is an area into which the second fluid is introduced to pass therethrough. The second inlet path 134 has a second inlet opening 134a for introducing the second fluid to the second inlet path 134 (refer to FIG. 14). The second inlet opening 134a is opened into the side surface of the flow passage structure 102, which faces one side in the lamination direction of the substrate 105 and the sealing plate 106 in the flow passage structure 102 and in the width direction orthogonal to the longitudinal direction (vertical direction) of the flow passage structure 102, and disposed at an upstream end of the second inlet path 134. The second inlet path 134 extends from the side surface of the flow passage structure 102 on which the second inlet opening 134a is formed toward the surface opposite thereto, is bent at a position corresponding to the first inlet path 132 of the inlet-side flow passageway 102a to which the second inlet path 134 belongs, and further linearly extends upward along the first inlet path 132. The second inlet path 134 is formed by the third groove part 114, of which opening formed on the rear surface 105b of the substrate 105 is sealed by the sealing plate 106.

The first junction part 136 (refer to FIG. 17) is an area for mutually joining the first fluid flowing through the first inlet path 132 and the second fluid flowing through the second inlet path 134, and falls into the scope of the junction part according to the present invention. The first junction part 136 leads to a downstream end (an upper end) of the first inlet path 132 and a downstream end (an upper end) of the second inlet path 134. The first junction part 136 is formed by the first hole part 120 of which opening on the front surface 105a of the substrate 105 is sealed by the sealing plate 106 bonded to the front surface 105a and of which opening on the rear surface 105b side of the substrate 105 is sealed by the sealing plate 106 bonded to the rear surface 105b. Into the first junction part 136, the first fluid linearly flows from the first inlet path 132, and the second fluid carried from the second inlet path 134 to the first junction part 136 is joined to the first fluid substantially in the horizontal direction while moving toward the first inlet path 132 (toward the front surface 105a of the substrate 105).

The first mixed fluid flow passage 138 is an area through which a mixed fluid passes formed by the first fluid and the second fluid which are joined and mixed with each other at the first junction part 136. The first mixed fluid flow passage 138 falls into the scope of the mixed fluid flow passage according to the present invention. The first mixed fluid flow passage 138 is configured so that the mixed fluid flows in a state of slug flow in which a plurality of fine slugs of the first fluid and a plurality of fine slugs of the second fluid are alternately aligned along the circulating direction. An upstream end of the first mixed fluid flow passage 138, that is, a lower end of a portion on the front surface 105a side of the substrate 105 in the first mixed fluid flow passage 138 leads to a downstream end (an upper end) of the first junction part 136. The first mixed fluid flow passage 138 linearly extends upward from the first junction part 136 to which the first mixed fluid flow passage 138 leads along an extension of the first inlet path 132, passes through the substrate 105 in the thickness direction to the rear surface 105b side of the substrate 105, extends linearly downward, and is bent to extend toward the side surface of the flow passage structure 102 on which the second inlet opening 134a is formed. A downstream end of the first mixed fluid flow passage 138 is opened into the side surface of the second inlet opening 134a on which the flow passage structure 102 is formed, and disposed above the second inlet opening 134a with a space therefrom. The mixed fluid flows through the first mixed fluid flow passage 138 in a state of slug flow, and within this mixed fluid, an interaction between the first fluid and the second fluid occurs through the contact interfaces between the slugs of the first fluid and the slugs of the second fluid. The first mixed fluid flow passage 138 is formed by a portion located between the first hole part 120 and the second hole part 122 of the first groove part 110 of which opening formed on the front surface 105a of the substrate 105 is sealed by the sealing plate 106, the second hole part 122 of which opening on the front surface 105a side of the substrate 105 is sealed by the sealing plate 106 bonded to the front surface 105a and of which opening on the rear surface 105b side of the substrate 105 is sealed by the sealing plate 106 bonded to the rear surface 105b, and the fourth groove part 116 of which opening formed on the rear surface 105b of the substrate 105 is sealed by the sealing plate 106 bonded to the rear surface 105b. A cross section of the first mixed fluid flow passage 138 in the direction orthogonal to the flow direction of the mixed fluid has a corresponding diameter of about 1 mm.

Each outlet-side flow passageway 102b includes a light fluid outlet path 140, a light-side inlet path 142, a second junction part 144 and a second mixed fluid flow passage 146.

The light fluid outlet path 140 is a flow passage for discharging a light fluid to be described later from an internal space 103a to be described later of the separation header 103. The light fluid outlet path 140 is formed within the flow passage structure 102 so as to lead to a portion to be described later where a light fluid to be described later is collected in an internal space 103a to be described later of the separation header 103, and constituted so that the light fluid enters from the internal space 103a of the separation header 103. An upstream end of the light fluid outlet path 140 is opened into the side surface of the flow passage structure 120 where the second inlet opening 134a and the downstream end of the first mixed fluid flow passage 138 are formed, and positioned above the downstream end of the first mixed fluid flow passage 138 with a space therefrom. The light fluid outlet path 140 has the same structure as that of the second inlet path 34. Concretely, the light fluid outlet path 140 extends from the side surface of the flow passage structure 102 on which the upstream end is formed toward the opposite side surface, is bent on an extension of the first inlet path 132 of the inlet-side flow passageway 102a corresponding to the outlet-side flow passageway 102b to which this light fluid outlet path 140 belongs, and linearly extends upward. The light fluid outlet path 140 is formed by the fifth groove part 118 of which opening formed on the rear surface 105b of the substrate 105 is sealed by the sealing plate 106 bonded to the rear surface 105b.

The light-side inlet path 142 is an area into which an additional fluid to be mixed to the light fluid is introduced to pass therethrough. The above-mentioned additional fluid may be a fluid of the same type as the first fluid or a fluid of the same type as the second fluid instead of fluids of types different from the first fluid and the second fluid. The light-side inlet path 142 has a light-side inlet opening (not shown) for introducing a fluid to the light-side inlet path 142. The light-side inlet opening is positioned at an upstream end of the light-side inlet path 142, and formed to be opened into the side surface opposite to the side surface of the flow passage structure 102 on which the second inlet opening 134a, a downstream end of the first mixed fluid flow passage 138 and an upstream end of the light fluid outlet path 140 are formed. The light-side inlet path 142 extends from the side surface of the flow passage structure 102 on which the light-side inlet opening is formed toward the opposite side surface, is bent at a position where the light fluid outlet path 140 of the outlet-side flow passageway 102b to which this light-side inlet path 142 belongs is bent, and linearly extends upward. The light-side inlet path 142 is formed by the second groove part 112 of which opening formed on the front surface 105a of the substrate 105 is sealed by the sealing plate 106 bonded to the front surface 105a. The light-side inlet path 142 leads to the light fluid outlet path 140 so that the additional fluid introduced to this light-side inlet path 142 is joined to the light fluid flowing through the light fluid outlet path 140. Concretely, the light-side inlet path 142 leads to the light fluid outlet path 40 through the second junction part 144.

The second junction part 144 is an area for mutually joining the light fluid flowing through the light fluid outlet path 140 and the additional fluid flowing through the light-side inlet path 142. This second junction part 144 leads to a downstream end of the light fluid outlet path 140 and a downstream end of the light-side inlet path 142. The second junction part 144 is formed by the third hole part 124 of which opening on the front surface 105a side of the substrate 105 is sealed by the sealing plate 106 bonded to the front surface 105a and of which opening on the rear surface 105b of the substrate 105 is sealed by the sealing plate 106 bonded to the rear surface 105b. In this second junction part 144, the light fluid carried from the light fluid outlet path 140 to the second junction part 144 is joined to the additional fluid, which has entered from the light-side inlet path 142, substantially in the horizontal direction while moving toward the light-side inlet path 142 (toward the front surface 105a of the substrate 105).

The second mixed fluid flow passage 146 is a flow path through which a mixed fluid passes formed by the light fluid and the additional fluid which are joined and mixed with each other in the second junction part 144. The second mixed fluid flow passage 146 is constituted so that the mixed fluid flowing through the second mixed fluid flow passage 146 flows in a state of slug flow. An upstream end of the second mixed fluid flow passage 146, that is, the lower end of the second mixed fluid flow passage 146 leads to a downstream end (an upper end) of the second junction part 144. This second mixed fluid flow passage 146 linearly extends upward from the second junction part 144 to which the second mixed fluid flow passage 146 leads. The downstream end of the second mixed fluid flow passage 146 is opened into the upper surface (the surface opposite to the surface on which the first inlet opening 32a is formed) of the flow passage structure 102. The mixed fluid flowing through the second mixed fluid flow passage 146 flows downstream in a state of slug flow, and within this mixed fluid, an interaction between the respective fluids constituting the mixed fluid occurs. A cross section orthogonal to the flow direction of the mixed fluid of the second mixed fluid flow passage 146 has a corresponding diameter of about 1 mm. The second mixed fluid flow passage 146 is formed by a portion located above the third hole part 124 in the second groove part 112 of which opening formed on the front surface 105a of the substrate 105 is sealed by the sealing plate 106.

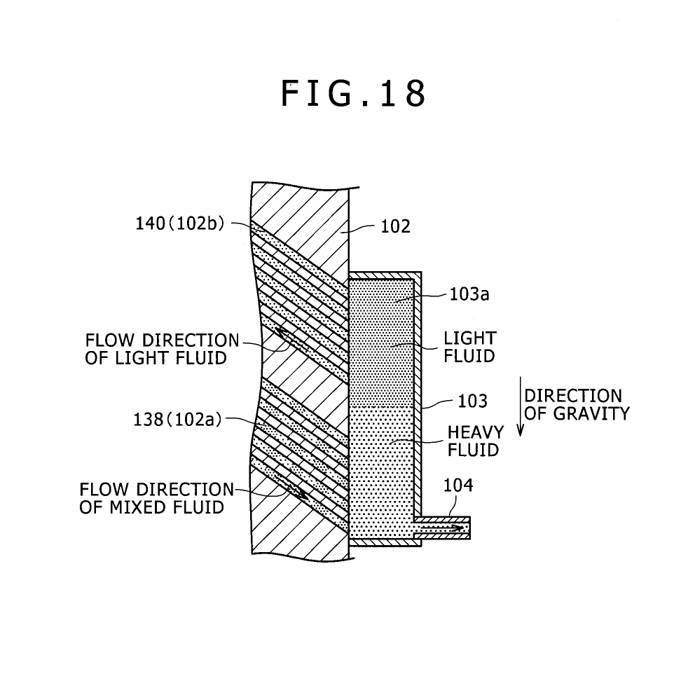

The separation header 103 (refer to FIG. 14) separates a fluid flowing through the inlet-side flow passageway 102a, concretely, a mixed fluid of the first fluid and the second fluid flowing through the first mixed fluid flow passage 138 into a light fluid with a small specific gravity and a heavy fluid with a larger specific gravity than that of the light fluid. This separation header 103 is attached to, in the outer surfaces of the flow passage structure 102, the side surface into which the downstream end of the first mixed fluid flow passage 138 and the upstream end of the light fluid outlet path 140 are opened. Concretely, the separation header 103 is attached to the side surface of the flow passage structure 102 so as to cover the downstream ends of all the first mixed fluid flow passages 138 and the upstream ends of all the light fluid outlet paths 140. The separation header 103 has an internal space 103a (refer to FIG. 18) communicating with the downstream ends of all the first mixed fluid flow passages 138 and the upstream ends of all the light fluid outlet paths 140 which are provided in the flow passage structure 102.

The internal space 103a separates the mixed fluid carried from the first mixed fluid flow passage 138 to the internal space 103a in accordance with the difference in specific gravity. Concretely, a cross section of the internal space 103a in the direction orthogonal to the flow direction of the mixed fluid entering the internal space 103a (the inflow direction of the mixed fluid) has a shape such that the mixed fluid entering the internal space 103a through the first mixed fluid flow passage 138 separates by itself into the light fluid and the heavy fluid in accordance with the difference in specific gravity. Concretely, a cross section of the internal space 103a in the direction orthogonal to the flow direction of the mixed fluid flowing into the internal space 103a has a corresponding diameter set so that the Froude number for the mixed fluid entering the internal space 103a is smaller than 1. More specifically, when the Froude number for the mixed fluid entering the internal space 103a is Fr, the field number Fr is represented by the following equation (1), and the corresponding diameter D of the cross section orthogonal to the flow direction of the mixed fluid entering the internal space 103a is set so that the Froude number Fr is smaller than 1.

Fr=U/(D·g)^{1/2} (1)

In this equation (1), U is the flow velocity of the mixed fluid flowing into the internal space 103a, and g is gravity acceleration. In the substantial range of use of the fluid circulation device, the flow rate of the fluid flowing through the fluid circulation device is about 10 ml/min or less per flow passageway. Since the mixed fluid flows into the internal space 103a from the first mixed fluid flow passages 138 of all the inlet-side flow passageways 102a formed within the flow passage structure 102, the flow rate of the mixed fluid flowing into the internal space 103a is a total flow rate of the mixed fluid flowing through the first mixed fluid flow passages 38 of all the inlet-side flow passageways 102a. For example, when 100 of inlet-side flow passageways 102a are formed within the flow passage structure 102, the flow rate of the mixed fluid flowing into the internal space 103a is about 1,000 ml/min in the substantial range of use of the fluid circulation device. The flow velocity U of the mixed fluid flowing into the internal space 103a is determined based on such a total flow rate of the mixed fluid. When the mixed fluid is circulated at such a flow rate within the substantial range of use of the fluid circulation device, the field number Fr is smaller than 1 if the corresponding diameter L of the internal space 103a is about 10 mm or more.

The Froude number Fr being smaller than 1 means that, in the internal space 103a, the effect of the gravity acting on the mixed fluid entering thereto is more dominant than the inertial force in the flow direction of the mixed fluid. Therefore, the heavy fluid in the mixed fluid entering the internal space 103a is settled down under the effect of the gravity which is stronger than the inertial force in the flow direction, and as a result, the mixed fluid separates by itself into the heavy fluid and the light fluid. As shown in FIG. 18, the heavy fluid is collected in the lower area of the internal space 103a, while the light fluid is suspended above the heavy fluid. The downstream end of the first mixed fluid flow passage 138 leads to a portion where the heavy fluid is collected in the internal space 103a of the separation header 103, that is, the lower area of the internal space 103a. The upstream end of the light fluid outlet path 40 leads to a portion where the light fluid is collected in the internal space 103a of the separation header 103, that is, an upper area of the internal space 103a located above the vertical central position of the internal space 103a. In a state where the light fluid and the heavy fluid are vertically separated in the internal space 103a as shown in FIG. 18, the light fluid in the mixed fluid flowing into the internal space 103a through the first mixed fluid flow passage 138 passes through a layer of the heavy fluid collected in the internal space 103a and is suspended above the layer of the heavy fluid.

The outlet nozzle 104 is provided on the separation header 103. The outlet nozzle 104 is designed to discharge the heavy fluid separated in the internal space 103a of the separation header 103, which falls into the scope of the heavy fluid outlet part according to the present invention. The outlet nozzle 104 is provided on the separation header 103 so as to lead to a portion where the heavy fluid is collected in the internal space 103a, that is, the lower area of the internal space 103a located below the vertical central position of the internal space 103a. Piping (not shown) is connected to the outlet nozzle 104 to discharge the heavy fluid from the internal space 103a through the outlet nozzle 104 and the piping connected thereto.

The thus-constituted fluid circulation device according to the third embodiment is used in a microreactor, a heat exchanger, an extractor or the like as described above. Among these usage examples, the case where the fluid circulation device of the third embodiment is used as an extractor and the case where it is used as a microreactor (reactor) are described.

First, the case where the fluid circulation device of the third embodiment is used as the extractor, that is, an extraction method using the fluid circulation device of the third embodiment is described.

In this extraction method, the above-mentioned fluid circulation device is used to mix an extraction object fluid containing an object to be extracted with an extracting agent that is a fluid for extracting the object to be extracted from the extraction object fluid, so as to extract the object to be extracted from the extraction object fluid to the extracting agent.

Concretely, a predetermined flow rate (velocity) of the extraction object fluid is introduced to each first inlet path 132 through each first inlet opening 132a, while a predetermined flow rate (velocity) of the extracting agent is introduced to each second inlet path 134 through each second inlet opening 134a (fluid introduction step).

The extraction object fluid introduced to each first inlet path 132 flows through the first inlet path 132 and enters the first junction part 136, while the extracting agent introduced to each second inlet path 134 flows through the second inlet path 134 and enters the first junction part 136. The extraction object fluid and the extracting agent are mutually joined so as to be mixed with each other at the first junction part 136. A mixed fluid formed by the extraction object fluid and the extracting agent, which have been joined together at the first junction part 136, enters the first mixed fluid flow passage 138 and flows downstream within the first mixed fluid flow passage 138 in a state of slug flow in which a plurality of fine slugs of the extraction object fluid and a plurality of fine slugs of the extracting agent are alternately aligned along the circulating direction of the mixed fluid. Within this mixed fluid, the object to be extracted is extracted from the extraction object fluid to the extracting agent through the contact interfaces between the slugs of the extraction object fluid and the slugs of the extracting agent (extraction step).

Thereafter, the mixed fluid is carried from each first mixed fluid flow passage 138 to the internal space 103a of the separation header 103 and separated into the light fluid and the heavy fluid in accordance with the difference in specific gravity within the internal space 103a, and the separated heavy fluid is discharged from the internal space 103a through the outlet nozzle 104, while the separated light fluid is discharged from the internal space 103a to each light fluid outlet path 140 (separation step). In the case where the extracting agent has a larger specific gravity than that of the extraction object fluid, for example, the extracting agent is settled down as the heavy fluid, and the extraction object fluid is suspended above the extracting agent as the light fluid in the internal space 103a. The extracting agent as the heavy fluid, which has been settled down, contains a large amount of the object to be extracted, and the content of the object to be extracted in the extraction object fluid as the light fluid suspended above the extracting agent is smaller than the content of the object to be extracted in the extraction object fluid introduced to the first inlet path 132.

The light fluid, which has been discharged from the internal space 103a to each light fluid outlet path 140, enters the second junction part 144 through the light fluid outlet path 140. Meanwhile, a predetermined flow rate of a new additional extracting agent is introduced to each light-side inlet path 142 through each light-side inlet opening, so that this extracting agent is carried from the light-side inlet path 142 to the second junction part 144 and joined to the light fluid.

A mixed fluid formed by the light fluid and the extracting agent, which have been joined and mixed together in the second junction part 144, enters the second mixed fluid flow passage 146 and flows downstream in a state of slug flow in which a plurality of fine slugs of the extracting object fluid and a plurality of fine slugs of the extracting agent are alternately aligned along the circulating direction. Within this mixed fluid, the object to be extracted is further extracted from the extraction object fluid to the extracting agent. Finally, the mixed fluid is discharged through the downstream end of each second mixed fluid flow passage 146 and collected.

The extraction method using the fluid circulation device of the third embodiment is performed as described above.

Next, the case of the fluid circulation device according to the third embodiment is used as a microreactor, that is, a reaction method using the fluid circulation device of the third embodiment is described.

In this reaction method, the above-mentioned fluid circulation device is used for mutually reacting a fluid of first reacting agent and a fluid of second reacting agent, which are mutually reactive, by mixing both the reacting agents.

Concretely, at a predetermined flow rate (flow velocity) of the first reacting agent is introduced to each first inlet path 132 through the first inlet opening 132a, while a predetermined flow rate (flow velocity) of the second reacting agent is introduced to each second inlet path 134 through each second inlet opening 134a (reacting agent introduction step).

The first reacting agent introduced to the first inlet path 32 flows through the first inlet path 132 and enters the first junction part 136, while the second reacting agent introduced to the second inlet path 134 flows through the second inlet path 134 and enters the first junction part 136. The first reacting agent and the second reacting agent are mutually joined so as to be mixed with each other at the first junction part 136. A mixed fluid formed by the first reacting agent and second reacting agent, which have been joined together at the first junction part 136, enters the first mixed fluid flow passage 138 and flows downstream within the first mixed fluid flow passage 138 in a state of slug flow in which a plurality of fine slugs of the first reacting agent and a plurality of fine slugs of the second reacting agent are alternately aligned along the circulating direction of the mixed fluid. Within this mixed fluid, the first reacting agent and the second reacting agent are mutually reacted through the contact interfaces of the slugs of the first reacting agent and the slugs of the second reacting agent to form a reaction product (reaction step).

Thereafter, the mixed fluid is carried from the first mixed fluid flow passage 138 to the internal space 103a of the separation header 103, and separated into the light fluid and the heavy fluid in the internal space 103a in accordance with the difference in specific gravity, so that the separated heavy fluid is discharged from the internal space 103a through the outlet nozzle 104 while the separated light fluid is discharged from the internal space 103a to each light fluid outlet path 140 (separation step). In the case where the fluid of the reaction product has a larger specific gravity than that of the other components in the mixed fluid, for example, the fluid of the reaction product is settled down as the heavy fluid in the internal space 103a, and the fluid of the other components is suspended on the upper side of the fluid of the reaction product as the light fluid. This light fluid is formed by an unreacted first reacting agent and an unreacted second reacting agent.

The light fluid discharged from the internal space 103a to each light fluid outlet path 140 is carried from the light fluid outlet path 140 into the second junction part 144. Meanwhile, a predetermined flow rate of an additional second reacting agent is introduced to each light-side inlet path 142 through each light-side inlet opening, so that this second reacting agent is carried to the second junction part 144 through the light-side inlet path 142 and joined to the light fluid.

A mixed fluid formed by the light fluid and the additional second reacting agent, which have been joined and mixed together at the second junction part 144, enters the second mixed fluid flow passage 146 and flows downstream within the second mixed fluid flow passage 146 in a state of slug flow in which a plurality of fine slugs of the unreacted first reacting agent and a plurality of fine slugs of the unreacted second reacting agent and the additional second reacting agent are alternately aligned along the circulating direction. Within this mixed fluid, further reaction of the first reacting agent and the second reacting agent occurs to produce a reaction product. Finally, the mixed fluid containing the reaction product is discharged from the downstream end of each second mixed fluid flow passage 46 and collected.

The reaction method using the fluid circulation device of the third embodiment is performed as described above.

In this third embodiment, an area of the contact interface between the first fluid and the second fluid per unit volume in the mixed fluid can be increased to promote the interaction between the first fluid and the second fluid, since the mixed fluid flows in a state of slug flow in which a plurality of slugs of the first fluid and a plurality of slugs of the second fluid are alternately aligned in the first mixed fluid flow passage 138. Concretely, in the extraction method using the fluid circulation device of the third embodiment, an area of the contact interface between the extraction object fluid as the first fluid and the extracting agent as the second fluid can be increased to promote the extraction of the object to be extracted from the extraction object fluid to the extracting agent. In the reaction method using the fluid circulation device of the third embodiment, an area of the contact interface between the first reacting agent as the first fluid and the second reacting agent as the second fluid can be increased to promote the reaction between both the reacting agents.

In the fluid circulation device of the third embodiment, a cross section in the direction orthogonal to the inflow direction of the mixed fluid in the internal space 103a of the separation header 103 leading to the downstream-side of the first mixed fluid flow passage 138 has a cross-sectional shape such that the mixed fluid, which has entered the internal space 103a through the first mixed fluid flow passage 138, is separated into the light fluid and the heavy fluid in accordance with the difference in specific gravity. Concretely, the cross section of the internal space 103a has a corresponding diameter set so that the Froude number Fr for the mixed fluid flowing into the internal space 103a is smaller than 1. Therefore, the effect of the gravity acting on the mixed fluid, which has entered the internal space 103a, becomes stronger than that of the inertial force in the flow direction of the mixed fluid, and the mixed fluid separates by itself into the light fluid and the heavy fluid in accordance with the difference in specific gravity within the internal space 103a. The heavy fluid separated in the internal space 103a can be discharged outside the fluid circulation device through the outlet nozzle 104, since the outlet nozzle 104 leads to a portion where the heavy fluid is collected in the internal space 103a of the separation header 103. Thus, when a substance to be separated and removed from the mixed fluid is contained in the heavy fluid, or when a substance to be obtained from the mixed fluid is contained in the heavy fluid, the heavy fluid containing such a substance can be discharged from the internal space 103a to the outside of the fluid circulation device through the outlet nozzle 104. Concretely, in the extraction method using the fluid circulation device of the third embodiment, when the extracting agent, which has extracted the object to be extracted from the extraction object fluid, is the heavy fluid, the extracting agent containing the object to be extracted can be discharged outside the fluid circulation device through the outlet nozzle 104. In the reaction method using the fluid circulation device of the third embodiment, when the fluid containing the reaction product formed by the reaction of the first reacting agent and the second reacting agent is the heavy fluid, the fluid containing the reaction product can be discharged outside the fluid circulation device through the outlet nozzle 104.

Further, in the fluid circulation device of the third embodiment, since the mixed fluid is separated into the heavy fluid and the light fluid in the internal space 103a of the separation header 103 provided within the fluid circulation device, and the heavy fluid is discharged through the outlet nozzle 104; the heavy fluid, which has been discharged from the fluid circulation device, does not require the separation operation when the heavy fluid is a desired fluid. When a desired product is contained in the heavy fluid or the light fluid, which has been separated in the internal space 103a of the separation header 103, the separation of the product from the light fluid or the heavy fluid can be performed with a simple separation operation, compared to the case where the product is separated from the mixed fluid which has been discharged from the flow circulation device in a state where plural types of fluids and the product flowing through the fluid circulation device are all mixed together.

In the fluid circulation device of the third embodiment, further, an additional fluid can be joined to cause an interaction to the light fluid flowing through the light-side inlet path 142, since the light-side inlet path 142 leads to the light fluid outlet path 140 through the second junction part 144 so that the additional fluid is joined to the light fluid flowing through the light fluid outlet path 140. In this third embodiment, furthermore, since the additional fluid can be joined to the light fluid, which has been separated from the heavy fluid in the internal space 103a of the separation header 103, in such a case where a substance which degrades the efficiency of the interaction between the light fluid and the additional fluid is contained in the mixed fluid and most of the substance is contained in the heavy fluid, which has been separated in the internal space 103a, the additional fluid can be joined to cause an interaction to the light fluid of which content of the substance is reduced. As a result, the efficiency of the interaction between the light fluid and the additional fluid can be improved. Concretely, in the extraction method using the fluid circulation device of the third embodiment, since the extraction efficiency is degraded when a large amount of the extracting agent, which has already extracted the object to be extracted, is contained in the mixed fluid, the extraction efficiency can be improved by joining a new extracting agent as the additional fluid to the light fluid after the extracting agent, which has already used in separation, is separated after extraction as the heavy fluid. In the reaction method using the fluid circulation device of the third embodiment, since the reaction efficiency is degraded when a large amount of the reaction product formed by the reaction between the first reacting agent and the second reacting agent is contained in the mixed fluid, the reaction efficiency can be improved by joining a new second reacting agent as the additional fluid to the light fluid after the heavy fluid containing the reaction product is separated.

In this third embodiment, since the downstream end of the first mixed fluid flow passage 138 leads to the lower area where the heavy fluid is collected in the internal space 103a of the separation header 103, the light fluid in the mixed fluid flowing from the first mixed fluid flow passage 138 to the internal space 103a passes through a layer of the heavy fluid collected in the lower area of the internal space 103a and is suspended above the layer of the heavy fluid in a state where the light fluid and the heavy fluid are vertically separated from each other in the internal space 103a. At this time, the contact interface between the light fluid and the heavy fluid is renewed, and the interaction between the light fluid and the heavy fluid can be promoted within the internal space 103a.

### Fourth Embodiment

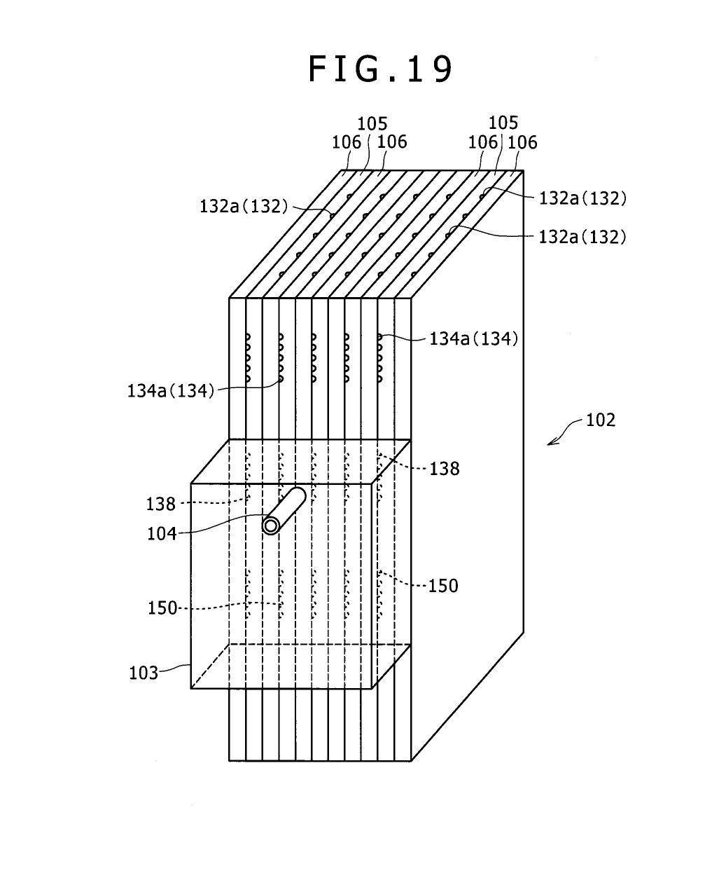

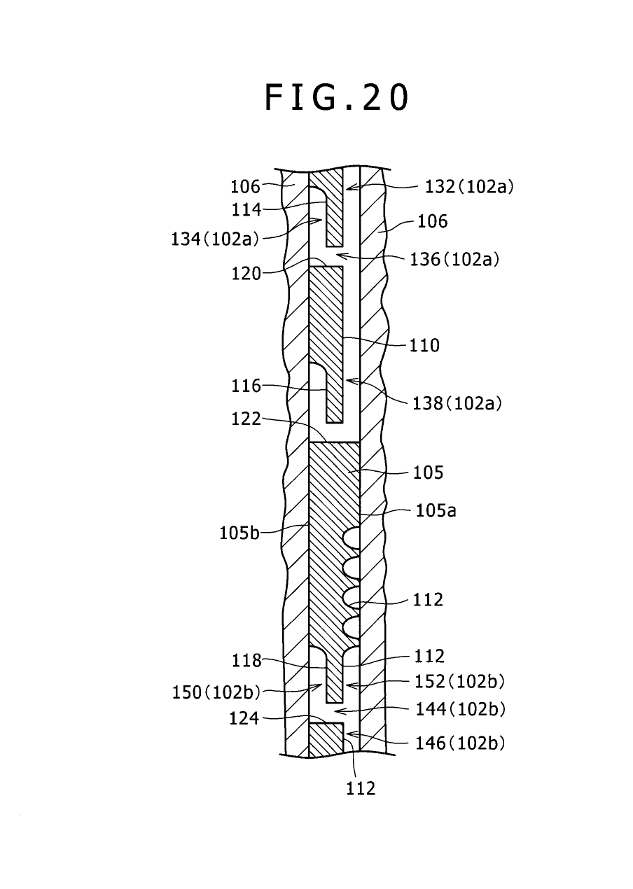

A configuration of a fluid circulation device according to a fourth embodiment of the present invention will be described with reference to FIGS. 19 to 21.

The fluid circulation device according to the fourth embodiment corresponds to the above-mentioned fluid circulation device of the third embodiment which is arranged upside down. Concretely, the fluid circulation device of the fourth embodiment is arranged, as shown in FIG. 19, so that the surface on which the first inlet opening 132a in the flow passage structure 102 is formed faces upward, and the surface having the downstream end of the second mixed fluid flow passage 146 of the flow passage structure 102 faces downward.

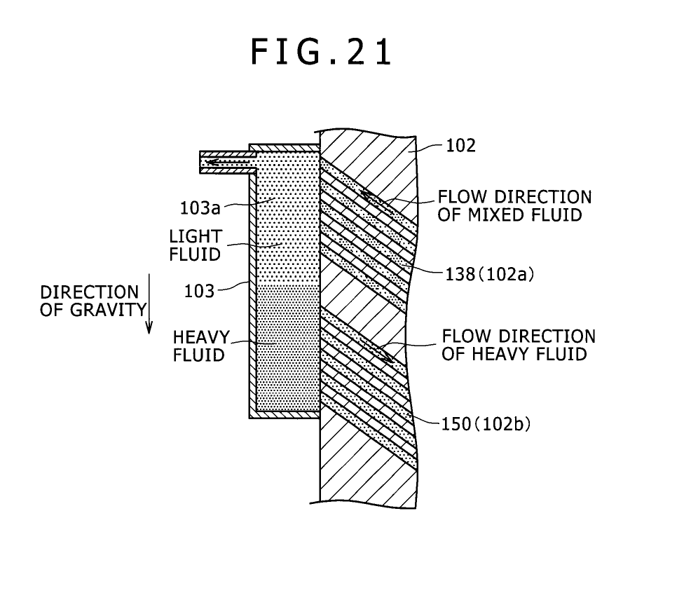

In this fourth embodiment, as shown in FIG. 21, the downstream end of the first mixed fluid flow passage 138 leads to a portion where the light fluid is collected in the internal space 103a of the separation header 103, that is, an upper area of the internal space 103a. In this fourth embodiment, further, each outlet-side flow passageway 102b has a heavy fluid outlet path 150 instead of the above-mentioned light fluid outlet path 140. This heavy fluid outlet path 150 is designed to discharge the heavy fluid, which has been separated in the internal space 103a of the separation header 103. The heavy fluid outlet path 150 has a structure in which the above-mentioned light fluid outlet path 140 is arranged upside down. The heavy fluid outlet path 150 is formed inside the flow passage structure 102 so as to lead to a portion where the heavy fluid is collected in the internal space 103a of the separation header 103. Concretely, the upstream end of the heavy fluid outlet path 150 leads to the portion where the heavy fluid is collected in the internal space 103a of the separation header 103, that is, a lower area of the internal space 103a, and the heavy fluid enters the heavy fluid outlet path 150 from the lower area.

In this fourth embodiment, each outlet-side flow passageway 102b has a heavy-side inlet path 152 instead of the above-mentioned light-side inlet path 142. This heavy-side inlet path 152 is an area for introducing an additional fluid to be mixed to the heavy fluid to pass therethrough. The additional fluid to be mixed to the heavy fluid may be a fluid of the same type as the first fluid or a fluid of the same type as the second fluid instead of fluids of different types from the first fluid and the second fluid. The heavy-side inlet path 152 has a structure in which the above-mentioned light-side inlet path 142 is arranged upside down. The heavy-side inlet path 152 leads to the heavy fluid outlet path 150 so that the additional fluid flowing through the heavy-side inlet path 152 is joined to the heavy fluid flowing through the heavy fluid outlet path 150. Concretely, the heavy-side inlet path 152 leads to the heavy fluid outlet path 150 through the second junction part 144.

The heavy fluid, which has entered the second junction part 144 through the heavy fluid outlet path 150, is joined to the additional fluid entered to the second junction part 144 through the heavy-side inlet path 152 substantially in the horizontal direction while moving toward the heavy-side inlet path 152. A mixed fluid formed by the heavy fluid and the additional fluid which are joined and mixed together at the second junction part 144 enters the second mixed fluid flow passage 146, and flows downstream within the second mixed fluid flow passage 146 in a state of slug flow. Within this mixed fluid, an interaction occurs. The mixed fluid is discharged to the lower side of the flow passage structure 102 and collected through the downstream end of the second mixed fluid flow passage 146.

In this fourth embodiment, further, the outlet nozzle 104 in the above-mentioned third embodiment is used as a nozzle for discharging the light fluid from the internal space 103a of the separation header 103. Namely, in this fourth embodiment, the outlet nozzle 104 falls into the scope of the light fluid outlet part according to the present invention. Concretely, in the fourth embodiment, the outlet nozzle 104 is provided in the separation header 103 so as to lead to a portion where the light fluid, which has been separated in the internal space 103a is collected in the internal space 103a, that is, the upper area of the internal space 103a, so that the light fluid separated from the mixed fluid, which has entered the internal space 103a, is discharged outside through this outlet nozzle 104.

In the fluid circulation device according to the fourth embodiment, the light fluid separated in the internal space 103a can be discharged from the fluid circulation device through the outlet nozzle 104, since the outlet nozzle 104 is provided in the separation header 103 so as to lead to a portion where the light fluid is collected in the internal space 103a. Therefore, when a substance to be removed by separation from the mixed fluid is contained in the light fluid or when a substance to be obtained from the mixed fluid is contained in the light fluid, the light fluid containing such a substance can be discharged from the internal space 103a to the outside of the fluid circulation device through the outlet nozzle 104.

In the fluid circulation device according to the fourth embodiment, an additional fluid can be joined to cause an interaction with the heavy fluid since the heavy-side inlet path 152 leads to the heavy fluid outlet path 150 through the second junction part 144 so as to join the additional fluid flowing through the heavy-side inlet path 152 to the heavy fluid flowing toward the heavy fluid outlet path 150. In the fourth embodiment, furthermore, since the additional fluid can be joined to the heavy fluid, which has been separated from the light fluid in the internal space 103a of the separation header 103, in such a case where a substance which degrades the efficiency of the interaction between the heavy fluid and the additional fluid is contained in the mixed fluid and most of the substance is contained in the light fluid, which has been separated in the internal space 103a, it is possible to join the additional fluid to the heavy fluid of which content of the substance is reduced so as to cause an interaction therebetween. Therefore, the efficiency of the interaction between the heavy fluid and the additional fluid can be improved.

In the fourth embodiment, since the downstream end of the first mixed fluid flow passage 138 leads to the upper area where the light fluid is collected in the internal space 103a of the separation header 103, as shown in FIG. 21, the heavy fluid in the mixed fluid entering the internal space 103a through the first mixed fluid flow passage 138 passes through a layer of the light fluid which has collected in the upper area of the internal space 103a, and is settled down below the light fluid, in a state where the light fluid and the heavy fluid are vertically separated in the internal space 103a. At this time, the contact interface between the light fluid and the heavy fluid is renewed, and the interaction between the light fluid and the heavy fluid can be promoted in the internal space 103a.

The effects other than the above by the fourth embodiment are the same as the effects by the third embodiment.

The embodiments disclosed herein should be considered to be illustrative and not restrictive in every respect. The scope of the present invention is defined not by the above description in the embodiments but by the appended claims, and all changes that fall within the meanings and scope equivalent to the claims are intended to be embraced by the claims.

For example, each component of the flow passages formed in the flow passage structure may have a structure other than the above-mentioned structures.

For example, the first inlet path may extend obliquely relative to the extending direction of the first mixed fluid flow passage or be bent. The second inlet path may linearly extend without bending. In this case, the second inlet path may extend in the direction parallel, oblique or orthogonal to the extending direction of the first inlet path. The first mixed fluid flow passage does not have to be formed to turn round from the front side of the substrate to the rear side as described above, and may be formed within one surface of the substrate. In this case, various shapes may be employed along the flow direction of the mixed fluid of the first mixed fluid flow passage. The light fluid outlet path, the heavy fluid outlet path, the light-side inlet path and the heavy-side inlet path may also be formed in various shapes other than the above. The second mixed fluid flow passage may be bent in the flow direction of the mixed fluid or be folded back a predetermined number of times.

The outlet-side flow passageway does not have to be provided with the light-side inlet path, the heavy-side inlet path, the second junction part and the second mixed fluid flow passage. Namely, in the above-mentioned third embodiment, the light fluid outlet path may extend to the upper end of the flow passage structure, and the downstream end of the light fluid outlet path may be opened into the upper surface of the flow passage structure. In the above-mentioned fourth embodiment, the heavy fluid outlet path may extend to the lower end of the flow passage structure and the downstream end of the heavy fluid outlet path may be opened into the lower surface of the flow passage structure.

The flow passage structure may be formed by a structure in which each one sealing plate is bonded to the front and rear surfaces of a single substrate on which grooves for forming the flow inlet-side passageway and the flow outlet-side passageway are formed, instead of the structure in which a number of the substrates 105 and the sealing plates 106 are laminated as described above.

Further, within the flow passage structure, a temperature conditioning flow passage for carrying a fluid for temperature control may be arranged between flow passageways adjacent to each other in the lamination direction of the substrate and the sealing plate.

The above-mentioned first fluid, second fluid and additional fluid may be liquid or gas, respectively.

The fluid circulation device may be arranged so that the longitudinal direction (the extending direction of the first inlet path) of the flow passage structure is rather oblique to the vertical direction.

Both the light fluid outlet path and the heavy fluid outlet path which lead to the internal space of the separation header may be formed in the flow passage structure, without the outlet nozzle on the separation header.

The flowing state of the mixed fluid flowing through the first mixed fluid flow passage 138 and through the second mixed fluid flow passage 146 is not limited to the state of slug flow as described above. The flowing state of the mixed fluid flowing through the mixed fluid flow passages 138, 146 depends on the physical properties and flow velocity of the fluids constituting the mixed fluid. Therefore, the mixed fluid flowing through the mixed fluid flow passages 138, 146 may be in a flowing state such that plural types of fluids contained in the mixed fluid flow in a laminar state. In this case, the fluids constituting the mixed fluids are interacted with each other through the contact interfaces between the laminar flows of the fluids within the mixed fluid flow passages 138, 146.

The inlet-side flow passageway may be formed by the first mixed fluid flow passage alone. Concretely, the first mixed fluid flow passage may extend so that the end opposite to the separation header side of the first mixed fluid flow passage is opened into the outer surface of the flow passage structure and the end opposite to the separation header of the first mixed fluid flow passage forms an inlet opening for introducing a fluid to the first mixed fluid flow passage. In this case, a mixed fluid, which has been prepared by mixing plural types of fluids outside the fluid circulation device, may be introduced to the first mixed fluid flow passage through the inlet opening and then introduced to the internal space of the separation header through the first mixed fluid flow passage.

What is claimed is:

1. A fluid treatment method for treating fluid by use of a flow passage structure, comprising the steps of:
circulating a mixed fluid formed by mutually-mixed plural types of fluid into a mixed fluid flow passage (mixed fluid circulation step);
separating, in a separation space leading to the downstream side of the mixed fluid flow passage, the mixed fluid entered from the mixed fluid flow passage into a light fluid with a small specific gravity and a heavy fluid with a larger specific gravity than that of the light fluid in accordance with the difference in specific gravity, the separation space having a cross-sectional shape such that the light fluid and the heavy fluid are mutually separated in accordance with the difference in specific gravity;
causing the heavy fluid to flow from the separation space to a heavy flow passage leading to an area where the heavy fluid is collected in the separation space; and
causing the light fluid to flow from the separation space to a light flow passage leading to an area where the light fluid is collected in the separation space.

2. The fluid treatment method according to claim 1, wherein a cross section of the separation space in the direction orthogonal to the flow direction of the mixed fluid flowing into the separation space has a corresponding diameter set so that the Froude number for the mixed fluid flowing into the separation space is smaller than 1.

3. The fluid treatment method according to claim 1, wherein the fluid treatment method is a separation method for separating the mixed fluid formed by mutually-mixed plural types of fluid into a light fluid with small a specific gravity and a heavy fluid with a larger in specific gravity than that of the light fluid.

4. The fluid treatment method according to claim 1, further comprising the steps of:
joining a first fluid introduced through a first inlet path and a second fluid introduced through a second inlet path together in a junction part leading to a downstream end of the first inlet path and a downstream end of the second inlet path so as to be mixed with each other; and
causing the mixed fluid formed by the first fluid and second fluid joined and mixed with each other in the junction part to flow to the mixed fluid flow passage leading to the downstream side of the junction part.

5. The fluid treatment method according to claim 4, wherein the fluid treatment method is an extraction method for extracting an object to be extracted from an extraction object fluid containing the object to be extracted into an extracting agent that is a fluid for extracting the object to be extracted from the extraction object fluid by mutually mixing the extraction object fluid and the extracting agent, in which
one fluid that is one of the extraction object fluid and the extracting agent is introduced to the first inlet path, the other fluid that is the other of the extraction object fluid and the extracting agent is introduced to the second inlet path, and
the object to be extracted is extracted, in the mixed fluid circulation step, from the extraction object fluid to the extracting agent through a contact interface between the extraction object fluid and the extracting agent within the mixed fluid.

6. The fluid treatment method according to claim 4, wherein the fluid treatment method is a reaction method for reacting a first reacting agent and a second reacting agent to each other, which are formed by mutually reactive fluids by mixing both the reacting agents with each other, in which
the first reacting agent is introduced to the first inlet path, the second reacting agent is introduced to the second inlet path, and
the first reacting agent and the second reacting agent are mutually reacted, in the mixed fluid circulation step, through a contact interface between the first reacting agent and the second reacting agent within the mixed fluid of the first reacting agent and the second reacting agent, while the mixed fluid passes through the mixed fluid flow passage.

7. The fluid treatment method according to claim 1, wherein the heavy flow passage has a heavy fluid outlet opening positioned at a downstream end of the heavy flow passage and formed so as to open into an outer surface of the flow passage structure, so that the heavy fluid is discharged out of the flow passage structure through the heavy fluid outlet opening.

8. The fluid treatment method according to claim 1, wherein the light flow passage has a light fluid outlet opening positioned at a downstream end of the light flow passage and formed so as to open into an outer surface of the flow passage structure, so that the light fluid is discharged out of the flow passage structure through the light fluid outlet opening.

9. The fluid treatment method according to claim 1, wherein the flow passage structure includes a heavy flow passage-side inlet path leading to the heavy flow passage, so that a fluid to be mixed to the heavy fluid is joined to the heavy fluid flowing through the heavy flow passage through the heavy flow passage-side inlet path.

10. The fluid treatment method according to claim 1, wherein the flow passage structure includes a light flow passage-side inlet path leading to the light flow passage, so that a fluid to be mixed to the light fluid is joined to the light fluid flowing through the light flow passage through the light flow passage-side inlet path.

11. The fluid treatment method according to claim 1, wherein the flow passage structure includes a substrate, a first sealing plate laminated on one side in the thickness direction of the substrate, and a second sealing plate laminated on the other side in the thickness direction of the substrate;
the substrate has a first surface facing one side in the thickness direction and a second surface facing the side opposite to the first surface;
a first surface-side groove part is formed on the substrate so as to extend along the first surface of the substrate and to open into the first surface, and the mixed fluid flow passage and the light flow passage are formed by sealing an opening of the first surface-side groove part formed on the first surface by means of the first sealing plate;
a second surface-side groove part is formed on the substrate so as to extend along the second surface of the substrate and to open into the second surface, and the heavy flow passage is formed by sealing an opening of the second surface-side groove part formed on the second surface by means of the second sealing plate; and
a hole part is formed on the substrate so as to extend through the substrate from the first surface side to the second surface side at a portion located, in the first surface-side groove part, between a portion constituting a downstream end of the mixed fluid flow passage and a portion constituting an upstream end of the light flow passage and to lead to a portion constituting the upstream end of the heavy flow passage in the second surface-side groove part, and the separation space is formed by sealing the opening on the first surface side of the hole part by means of the first sealing plate and sealing the opening on the second surface side of the hole part by means of the second sealing plate.

12. The fluid treatment method according to claim 1, wherein
the flow passage structure includes a substrate, a first sealing plate laminated on one side in the thickness direction of the substrate, and a second sealing plate laminated on the other side in the thickness direction of the substrate;
the substrate has a first surface facing one side in the thickness direction and a second surface facing the opposite side to the first surface;
a first surface-side groove part is formed on the substrate so as to extend along the first surface of the substrate and to open into the first surface, and the light flow passage is formed by sealing an opening of the first surface-side groove part formed on the first surface by means of the first sealing plate;
a second surface-side groove part is formed on the substrate so as to extend along the second surface of the substrate and to open into the second surface, and the mixed fluid flow passage and the heavy flow passage are formed by sealing an opening of the second surface-side groove part formed on the second surface by means of the second sealing plate; and
a hole part is formed on the substrate so as to extend through the substrate from the second surface side to the first surface side at a portion located, in the second surface-side groove part, between a portion constituting a downstream end of the mixed fluid flow passage and a portion constituting an upstream end of the heavy flow passage and to lead to a portion constituting an upstream end of the light flow passage in the first surface-side groove part, and the separation space is formed by sealing the opening on the first surface side of the hole part by means of the first sealing plate and sealing the opening on the second surface side of the hole part by means of the second sealing plate.

13. The fluid treatment method according to claim 1, wherein the mixed fluid flow passage is formed within the flow passage structure, a separation header attached to the flow passage structure is further used, and the separation space is formed within the separation header.
